(19) United States
(12) Patent Application Publication
(10) Pub. No.: US 2024/0109325 A1
(43) Pub. Date: Apr. 4, 2024

(54) WIPING MEMBER, WIPER, WIPING METHOD, AND LIQUID DISCHARGE DEVICE

(71) Applicant: KYOCERA CORPORATION, Kyoto-shi, Kyoto (JP)

(72) Inventors: Masaya KIMACHI, Kirishima-shi, Kagoshima (JP); Takuya TSUTSUMI, Kirishima-shi, Kagoshima (JP); Tatsumi UWAI, Kirishima-shi, Kagoshima (JP); Ryota IMANISHI, Kirishima-shi, Kagoshima (JP)

(21) Appl. No.: 18/550,681

(22) PCT Filed: Mar. 8, 2022
(86) PCT No.: PCT/JP2022/009963

§ 371 Date: Sep. 15, 2023

(30) Foreign Application Priority Data
Mar. 30, 2021 (JP) 2021-056601

(51) Int. Cl. B41J 2/165; B41J 29/17

(52) U.S. Cl. CPC B41J 2/16535; B41J 2/16544; B41J 29/17; B41P 2235/20

(57) ABSTRACT

A wiping member includes an elastic member and a liquid retention member. The elastic member includes a first surface and a second surface facing in different directions. The liquid retention member overlaps the elastic member over the first surface and the second surface, and has liquid retention properties.

### CROSS-REFERENCE TO RELATED APPLICATIONS

This application is national stage application of International Application No. PCT/JP2022/009963, filed on Mar. 8, 2022, which designates the United States, and which claims the benefit of priority from Japanese Patent Application No. 2021-056601, filed on Mar. 30, 2021.

### TECHNICAL FIELD

The present disclosure relates to a wiping member, a wiper, a wiping method, and a liquid discharge device.

### BACKGROUND OF INVENTION

A liquid discharge head (e.g., an inkjet head) that discharges droplets (e.g., ink droplets) toward a recording medium (e.g., paper) is known. Such a liquid discharge head includes, for example, a discharge surface on which multiple nozzles for discharging droplets open. Also known is a technique of wiping by sliding a wiping member against the discharge surface (e.g., Patent Document 1 below). Wiping can remove, for example, solidified ink deposited on the discharge surface. For example, some of the discharged ink droplets are atomized and fly, and the atomized ink adheres to the discharge surface and solidifies, forming the solidified ink. Removing the solidified ink, for example, reduces the probability that each of the multiple nozzles is partially or completely blocked by the solidified ink. Consequently, the discharge characteristics of the liquid discharge head are stabilized.

Patent Document 1 discloses a wiping member (referred to as a cleaner in Patent Document 1) including an elastic member (referred to as a spatula-shaped wiper in Patent Document 1) and a water absorptive member (referred to as a rubbing member in Patent Document 1). The rubbing member is glued to only one of the multiple faces of the spatula-shaped wiper.

### CITATION LIST

### Patent Literature

Patent Document 1: JP 4-338552 A

### SUMMARY

According to an aspect of the present disclosure, a wiping member includes an elastic member and a liquid retention member. The elastic member includes a first surface and a second surface facing in different directions. The liquid retention member overlaps the elastic member over the first surface and the second surface, and has liquid retention properties.

According to an aspect of the present disclosure, a wiper includes the wiping member and a support member configured to support the wiping member. The wiping member includes a front end, a rear end, a body portion, and a held portion. The front end and the rear end are end portions on both sides in a direction along the first surface. The body portion includes the front end. The held portion is located closer to the rear end than the body portion. The support member includes a holding surface and a convex curved surface. The holding surface is in contact with the held portion from a side that the second surface faces to enable deflection of the body portion toward the side that the second surface faces. The convex curved surface is connected to the holding surface on a side of the front end and curves away from the wiping member being in a non-deflecting state toward the side that the second surface faces the closer the convex curved surface is located to the front end.

According to an aspect of the present disclosure, a wiper includes the wiping member, a first support member, and a second support member. The first support member is in contact with the wiping member from a side that the first surface faces. The second support member is in contact with the wiping member from a side that the second surface faces.

According to an aspect of the present disclosure, a wiping method includes a wiping step of wiping, with the wiping member, a discharge surface of a liquid discharge head on which a nozzle opens. The wiping member includes a front end, a rear end, a body portion, and a held portion. The front end and the rear end are end portions on both sides in a direction along the first surface. The body portion includes the front end. The held portion is located closer to the rear end than the body portion. The liquid retention member includes a first portion and a second portion. The first portion is located on the body portion and on the first surface. The second portion is located on the body portion and on the second surface. The wiping step includes a contact step and a first step. In the contact step, the body portion is brought into contact with the discharge surface while the held portion is held to enable deflection of the body portion. In the first step, the wiping member is moved in a first direction in which the first surface faces in the held portion, being a direction along the discharge surface, with the body portion in contact with the discharge surface. During this period, the wiping member is moved in the first direction while the second portion is pressed toward the second surface with the first portion in contact with the discharge surface.

According to an aspect of the present disclosure, a wiping method includes a wiping step of wiping, with the wiping member, a discharge surface of a liquid discharge head on which a nozzle opens. The wiping member includes a front end, a rear end, a body portion, and a held portion. The front end and the rear end are end portions on both sides in a direction along the first surface. The body portion includes the front end. The held portion is located closer to the rear end than the body portion. The liquid retention member includes a first portion and a second portion. The first portion is located on the body portion and on the first surface. The second portion is located on the body portion and on the second surface. The wiping step includes a contact step, a first step, and a second step. In the contact step, the body portion is brought into contact with the discharge surface while the held portion is held to enable deflection of the body portion. In the first step, the wiping member is moved in a first direction in which the first surface faces in the held portion, the first direction being a direction along the discharge surface, with the first portion in contact with the discharge surface. In the second step, the wiping member is moved in a second direction in which the second surface faces in the held portion, the second direction being a direction along the discharge surface, with the second portion in contact with the discharge surface.

According to an aspect of the present disclosure, a liquid discharge device includes the wiping member and a transport device. The transport device causes the wiping member to wipe a discharge surface of the liquid discharge head on which a nozzle opens by moving the wiping member and the liquid discharge head relative to each other.

### BRIEF DESCRIPTION OF THE DRAWINGS

FIG. 1 is a perspective view schematically illustrating a liquid discharge head and a wiping member according to an embodiment.

FIG. 2A is a side view or a cross-sectional view illustrating an example of an attachment method for attaching a liquid retention member to an elastic member in the wiping member in FIG. 1.

FIG. 2B is a view illustrating a continuation of FIG. 2A.

FIG. 3A is a view illustrating an attachment method according to a variation.

FIG. 3B is a view illustrating an attachment method according to another variation.

FIG. 3C is a view illustrating an attachment method according to still another variation.

FIG. 4A is a side view or a cross-sectional view illustrating a wiping member according to a variation.

FIG. 4B is a side view or a cross-sectional view illustrating a wiping member according to another variation.

FIG. 5 is a side view or a cross-sectional view illustrating the wiping member in FIG. 1 and a holding unit holding the wiping member.

FIG. 6A is a side view or a cross-sectional view illustrating the wiping member and the holding unit in FIG. 5 during wiping.

FIG. 6B is another side view or another cross-sectional view illustrating the wiping member and the holding unit in FIG. 5 during wiping.

FIG. 7A is a side view or a cross-sectional view illustrating a wiping member and a holding unit according to a variation.

FIG. 7B is a side view or a cross-sectional view illustrating a wiping member and a holding unit according to another variation.

FIG. 8A is a cross-sectional view illustrating an example of a fixation method for fixing two support members of the holding unit in FIG. 5.

FIG. 8B is a cross-sectional view illustrating another example of a fixation method for fixing the two support members of the holding unit in FIG. 5.

FIG. 9A is a side view or a cross-sectional view illustrating an example of a state in which the support member of the holding unit in FIG. 5 is in contact with the wiping member.

FIG. 9B is a view illustrating a continuation of FIG. 9A.

FIG. 10A is a side view or a cross-sectional view illustrating another example of a state in which the support member of the holding unit in FIG. 5 is in contact with the wiping member.

FIG. 10B is a view corresponding to FIG. 10A at a timing different from a timing in FIG. 10A.

FIG. 11A is a schematic side view or a cross-sectional view illustrating an example of an operation procedure of wiping.

FIG. 11B is a view illustrating a continuation of FIG. 11A.

FIG. 11C is a view illustrating a continuation of FIG. 11B.

FIG. 11D is a view illustrating a continuation of FIG. 11C.

FIG. 12A is a schematic side view or a cross-sectional view illustrating another example of an operation procedure of wiping.

FIG. 12B is a view illustrating a continuation of FIG. 12A.

FIG. 12C is a view illustrating a continuation of FIG. 12B.

FIG. 12D is a view illustrating a continuation of FIG. 12C.

FIG. 13A is a schematic view illustrating an example of a supply method for supplying a cleaning liquid to the wiping member in FIG. 1.

FIG. 13B is a schematic view illustrating another example of a supply method for supplying a cleaning liquid to the wiping member in FIG. 1.

FIG. 13C is a schematic view illustrating still another example of a supply method for supplying a cleaning liquid to the wiping member in FIG. 1.

FIG. 14A is a schematic view illustrating an example of a printer including the wiping member in FIG. 1.

FIG. 14B is a schematic view illustrating the printer in FIG. 14A in a state different from a state in FIG. 14A.

FIG. 15A is a schematic view illustrating another example of a printer including the wiping member in FIG. 1.

FIG. 15B is a schematic view illustrating the printer in FIG. 15A in a state different from a state in FIG. 15A.

FIG. 16 is a side view of yet another example of a printer including the wiping member in FIG. 1.

FIG. 17 is a plan view of the printer in FIG. 16.

FIG. 18 is a perspective view illustrating an example of a configuration of a wiper used in the printer in FIG. 16.

### DESCRIPTION OF EMBODIMENTS

An embodiment of the present disclosure will be described below with reference to the accompanying drawings. Drawings used in the following description are schematic, and dimensional ratios and the like on the drawings do not always match the actual ones. In multiple drawings illustrating the same member, dimensional ratios and the like may not match each other in order to exaggerate shapes or the like. Details may be omitted.

In the description of the embodiment, various aspects different from the illustrated examples will also be mentioned, and multiple variations will be illustrated. However, for the sake of convenience, without special mention, descriptions may be based on the illustrated embodiment (excluding variations). Various aspects of one member may be appropriately combined with various aspects of another member. However, for the sake of convenience, without special mention, in the description of another member, the illustrated embodiment for one member may be taken as an example. In the description of the variations and the like, basically, differences from the example previously described will be described. Matters not described may be assumed to be the same as, and/or similar to, or inferred from the examples previously described.

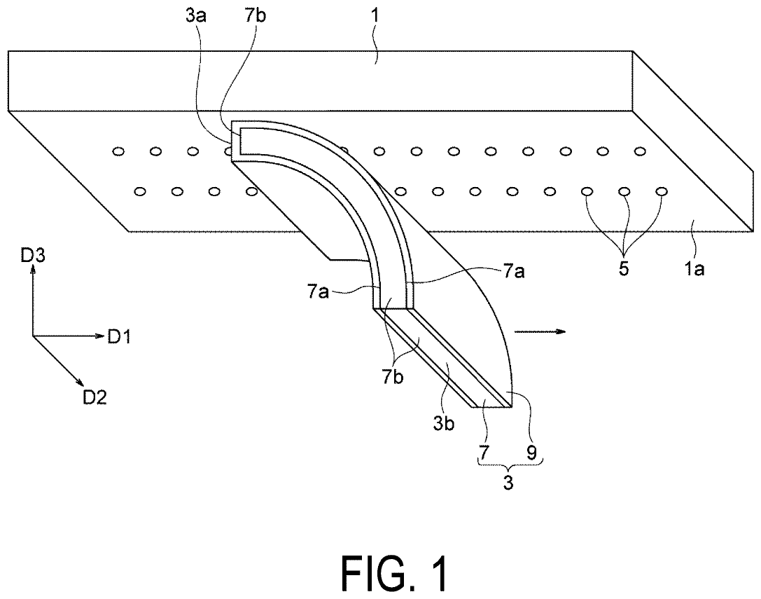

FIG. 1 is a perspective view schematically illustrating a liquid discharge head 1 (hereinafter, may be simply referred to as “head 1”) and a wiping member 3 according to an embodiment.

In FIG. 1, an orthogonal coordinate system D1-D2-D3 is shown. The head 1 and the wiping member 3 may be used in any orientation with respect to the vertical direction. For the sake of convenience, the following description may assume that a +D3 side is vertically upward.

The head 1 is a device that discharges droplets. The wiping member 3 is a member that wipes the head 1. FIG. 1 illustrates a state in which wiping is performed. In normal use of the head 1, unlike in FIG. 1, the head 1 and the wiping member 3 are disposed apart from each other. In the following, the head 1 will be described first, and then the wiping member 3 will be described. Unlike in FIG. 1, the head 1 may be described on the premise that the wiping member 3 is located apart from the head 1.

Liquid Discharge Head

The head 1 is a device that discharges droplets to a −D3 side. The droplets are, for example, ink droplets. In this case, for example, the discharged ink droplets adhere to an object (not illustrated) (e.g., a recording medium such as paper) placed on the −D3 side with respect to the head 1. Thus, printing is performed on the object. The head 1 is included in, for example, an inkjet printer (not illustrated).

A configuration of the head 1 that performs operation described above may be any one of various configurations or may be the same as, and/or similar to known configurations. In the following description, details of the head 1 may be omitted as appropriate. In the following description, for the sake of convenience, the description may be made under the assumption that the head 1 is included in an inkjet printer that prints on a recording medium.

The head 1 includes a discharge surface 1a facing the −D3 side. The discharge surface 1a includes one or more (multiple in the illustrated example) nozzles 5 that discharge droplets. The term “discharge surface 1a” may refer to an entire surface of the head 1 on the −D3 side, or may refer to only a region of the surface on the −D3 side where the multiple nozzles 5 are arranged.

The discharge surface 1a is, for example, flat. However, depending on an application of the head 1, the discharge surface 1a may be curved or the like. A planar shape of the discharge surface 1a can be set freely. In the illustrated example, the discharge surface 1a is elongated in a D1 direction. In more detail, the discharge surface 1a is substantially rectangular with the D1 direction as a longitudinal direction. The dimensions of the discharge surface 1a can be set freely. For example, a length of the discharge surface 1a in the D1 direction may be equal to or greater than 1 cm and equal to or less than 1 m, or may be outside this range. For example, a length of the discharge surface 1a in a D2 direction (a width of the discharge surface 1a) may be equal to or greater than 1 mm and equal to or less than 20 cm, or may be outside this range. The discharge surface 1a may be made of any material, for example, metal or resin. A water-repellent film may be provided to cover the metal or resin.

The shape and dimensions of each nozzle can be set freely. The number and arrangement of the multiple nozzles 5 can be also determined freely. For example, the multiple nozzles 5 are arranged in one or more (multiple (two) in the illustrated example) rows. A direction in which the rows extend (a direction in which the nozzles 5 are arranged in each row) is, for example, along the D1 direction (from another viewpoint, the longitudinal direction of the discharge surface 1a). The direction in which the rows extend may be parallel to the D1 direction (illustrated example) or may be inclined with respect to the D1 direction.

By forming the row with the multiple nozzles 5, a strip-shaped image having a width in the direction in which the row extends is formed by discharging ink droplets from the head 1 while moving the head 1 and the recording medium relative to each other in a direction intersecting the row (e.g., the D2 direction). The nozzles 5 are arranged so that the positions of the nozzles 5 do not overlap each other in the multiple rows when viewed from a direction of the relative movement between the head 1 and the recording medium (e.g., the D2 direction), which allows dots to be formed on the recording medium at a pitch narrower than a pitch of the nozzles 5 in each row.

The head 1 may be, for example, a piezoelectric head or a thermal head. In the piezoelectric head, droplets are discharged from the nozzle 5 by applying pressure to a liquid by a piezoelectric material. In the thermal head, bubbles are formed in a liquid by heat of a heating element, and droplets are discharged from the nozzle 5 by pressure due to the formation of bubbles.

The head 1 may be used, for example, in a so-called line printer or in a serial printer.

The head 1 used in a line printer has a length substantially over an entire length (width) of the recording medium in the D1 direction. The head 1 discharges ink droplets while moving relative to the recording medium in the D2 direction. Thus, for example, an image is formed over substantially an entire recording medium. A plurality of the heads 1 may be arranged to form a unit that functions as a head of the line printer. An example of this aspect will be given later.

The head 1 used in the serial printer repeats an operation of forming a strip-shape image by discharging ink droplets while moving relative to the recording medium in the D2 direction and an operation of moving relative to the recording medium in the D1 direction. Thus, a plurality of strip-shaped images are continuously formed. Consequently, an image is formed over substantially an entire recording medium.

Liquid Discharged by Head

The liquid discharged by the head 1 may be, for example, ink. The ink contains, for example, a colorant and a solvent. The colorant may be, for example, a pigment or a dye. The solvent may be, for example, water or an organic solvent. Ink and paint are sometimes distinguished in some technical fields, but they are not distinguished in the description of the embodiment.

The liquid discharged by the head 1 may be a liquid other than ink. For example, the liquid may be a coating agent that does not contain a colorant. The liquid may be printed on a circuit board to form an electrically conductive layer. The liquid may be a liquid chemical agent or a liquid containing a chemical agent.

Wiping Member

The wiping member 3 is a member that wipes the discharge surface 1a. As described in the BACKGROUND OF INVENTION section, by wiping the discharge surface 1a, for example, the solidified ink is removed, thus stabilizing the discharge characteristics of the head 1. When the liquid discharged by the head 1 is not ink, for example, the solidified liquid and/or dust other than the liquid is removed, thus stabilizing the discharge characteristics of the head 1.

The wiping member 3 includes an elastic member 7 and a liquid retention member 9 (liquid absorptive member) located on a surface of the elastic member 7. The wiping member 3 including the elastic member 7, for example, makes it easy to keep the surface of the wiping member 3 (from another viewpoint, the liquid retention member 9) in contact with the discharge surface 1a without gaps and/or to set contact pressure appropriately. Consequently, for example, a cleaning effect by wiping is improved. The wiping member 3 including the liquid retention member 9, for example, can retain a cleaning liquid in the liquid retention member 9, thereby improving a cleaning effect by wiping.

The wiping member 3 may have any one of various configurations as long as the wiping member 3 is composed of the elastic member 7 and the liquid retention member 9. For example, the wiping member 3 may have a configuration the same as, and/or similar to known configurations. For example, the overall shape and dimensions of the wiping member 3 may be the same as, and/or similar to those of known configurations. In the following, an overall configuration of the wiping member 3 will be described first, and then the elastic member 7 and the liquid retention member 9 will be described.

Overall Configuration of Wiping Member

The ways in which the wiping member 3 comes into contact and moves with respect to the discharge surface 1a during wiping may be set as appropriate. In the illustrated example, the wiping member 3 is in contact with the discharge surface 1a over the entire length thereof (or only the region where the multiple nozzles 5 are arranged as described above) in the D2 direction. As indicated by an arrow, the wiping member 3 moves relative to the discharge surface 1a in the D1 direction. Thus, substantially the entirety of the discharge surface 1a can be wiped.

The wiping member 3 may move relative to the discharge surface 1a to a +D1 side to perform wiping (illustrated example), may move relative to the discharge surface 1a to a −D1 side to perform wiping, or may move both sides to perform wiping. In the following description, without special mention, the relative movement to either side may be taken as an example. In this case, the relative movement to the other side may be performed in the same, and/or a similar manner to the relative movement to the one side. In the following description, a diagram illustrating the movement to the −D1 side and a diagram illustrating the movement to the +D1 side may be described as diagrams illustrating the same state.

Unlike the illustrated example, the wiping member 3 may move relative to the discharge surface 1a in a direction other than the D1 direction to perform wiping. Examples of such a direction include the D2 direction and a direction inclined to the D1 direction. The wiping member 3 need not move linearly relative to the discharge surface 1a, but may move in an arc (in a broader concept, in a curve) relative to the discharge surface 1a as a vehicle wiper. The wiping member 3 may change a direction of relative movement to the discharge surface 1a in various directions.

Unlike the illustrated example, when the discharge surface 1a is viewed in a plan view, the wiping member 3 need not be long enough to span the discharge surface 1a in a direction orthogonal to the direction of the relative movement to the discharge surface 1a (the D2 direction in the illustrated example). In this case, the wiping member 3 may wipe the entire discharge surface 1a by reciprocating with respect to the discharge surface 1a while changing a position of the wiping member 3 in the direction orthogonal to the direction of movement relative to the discharge surface 1a. Alternatively, two or more wiping members 3 may be used for one head 1. Contrary to the above, when multiple heads 1 are arranged, the wiping member 3 may have a size that covers the multiple heads 1, thereby wiping the multiple discharge surfaces 1a simultaneously.

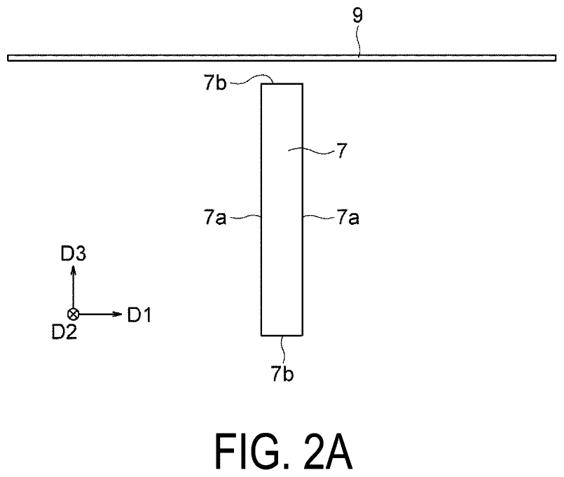

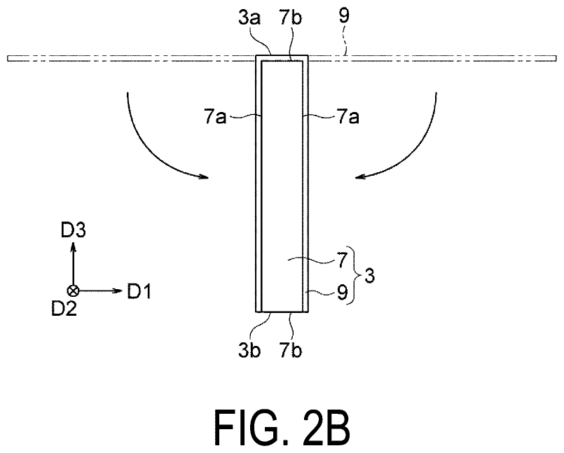

The wiping member 3 has elasticity on the whole, for example, by including the elastic member 7. In FIG. 1, the wiping member 3 is elastically deformed by being pressed against the head 1. The shape of the wiping member 3 when the wiping member 3 is not elastically deformed will be described later with reference to FIG. 2B and the like. In the following description, without notice, the shape, dimensions, and the like of the wiping member 3 (constituent elements thereof) may be described under the assumption that the wiping member 3 is not elastically deformed. For example, when referring to a length in a D3 direction, it may be assumed that the wiping member 3 is not elastically deformed.

The shape of the wiping member 3 may be an appropriate shape. In the illustrated example, the shape of the wiping member 3 is substantially a flat plate shape (blade shape) having a constant thickness. The planar shape of the wiping member having a flat plate shape is rectangular. In other words, the shape of the wiping member 3 is a thin rectangular parallelepiped shape. The wiping member 3 is pressed against the discharge surface 1a with a portion on a side of one side (sometimes referred to as a front end 3a) of the rectangle facing the discharge surface 1a. Then, a portion on a side of one side (sometimes referred to as a rear end 3b) on the opposite side to the front end 3a is held and moved in the D1 direction. Thus, wiping is performed. Examples of the shape of the wiping member 3 other than the illustrated example will be described later.

In the wiping member 3 having a rectangular flat plate shape, the rectangle may or may not be a square. In the latter case, a pair of opposite sides, which are the front end side 3a and the rear end side 3b, may be long sides or short sides. The relative dimensions and absolute dimensions of lengths of all sides and the thickness of the wiping member 3 can be set freely. However, in light of a concept of a plate, the thickness is less than the length of any of the four sides. For example, the length of the short side and/or the length of the long side may be at least 5 or 10 times the thickness. As can be understood from the above description, each dimension may be set from various dimensions in accordance with the specific area of the discharge surface 1a. For example, the length of the short side and/or the length of the long side may be equal to or greater than 1 mm and equal to or less than 1 m, or may be outside this range.

Elastic Member

The shape and dimensions of the elastic member 7 are, for example, smaller than the shape and dimensions of the wiping member 3 (described above) by amounts corresponding to the shape and dimensions of the liquid retention member 9 provided. In the illustrated example, the thickness of the liquid retention member 9 is relatively small, so the above-described description of the shape and dimensions of the wiping member 3 may be applied to the shape and dimensions of the elastic member 7 as long as no contradiction or the like occurs. When the thickness of the liquid retention member 9 is relatively large, the above-described description of the shape and dimensions of the wiping member 3 may also be applied to the shape and dimensions of the elastic member 7. In this case, the shape and dimensions of the wiping member 3 may be smaller than the shape and dimensions described above by amounts corresponding to the shape and dimensions of the liquid retention member 9 provided.

In the illustrated example, the shape of the elastic member 7 is substantially a rectangular flat plate shape in a state where elastic deformation does not occur. In other words, the elastic member 7 includes two main surfaces 7a facing opposite sides and four side surfaces 7b connecting outer edges of the two main surfaces 7a. The term “main surfaces” refers to the widest surfaces (front surface and back surface) of the plate. The two main surfaces 7a are, in other words, two surfaces facing opposite sides and are rear surfaces of the other surfaces. The two main surfaces 7a and the four side surfaces 7b are, in other words, surfaces facing in different directions.

The material of the elastic member 7 is, for example, elastomer. The elastomer may be a thermosetting elastomer (so-called rubber) or a thermoplastic elastomer (elastomer in a narrow sense). The thermosetting elastomer may be, for example, a vulcanized rubber (rubber in a narrow sense) or a thermosetting resin-based elastomer. The hardness of the elastic member 7 may be set appropriately. For example, the hardness measured by a Type A durometer specified in the Japanese Industrial Standard (JIS) K6253 may be 30 or more and 80 or less, or 60 or more and 80 or less.

Liquid Retention Member

The liquid retention member 9 overlaps the elastic member 7 over two or more of the multiple surfaces of the elastic member 7 (two main surfaces 7a and four side surfaces 7b in the illustrated example). With this configuration, for example, a surface area capable of retaining the liquid can be increased, or the cleaning liquid can be retained on a surface other than the surface pressed against the discharge surface 1a. As a result, for example, the amount of the cleaning liquid can be increased and/or a supply method for supplying the cleaning liquid to the discharge surface 1a can be diversified.

The two or more surfaces on which the liquid retention member 9 is placed may be selected as appropriate. From another point of view, the shape and dimensions of the liquid retention member 9 in a planar shape assuming that the liquid retention member 9 is developed in a flat plate shape may be set as appropriate. In the illustrated example, the liquid retention member 9 is provided over three surfaces: the two main surfaces 7a and the side surface 7b on the side of the front end 3a. The liquid retention member 9 overlaps, for example, the entirety of the three surfaces. In other words, the liquid retention member 9 has a shape in which three rectangular regions are joined together.

Unlike the illustrated example, the liquid retention member 9 may partially overlap the three surfaces. For example, the liquid retention member 9 may have a width narrower than a width of the elastic member 7 (in the D2 direction). Conversely, the width of the liquid retention member 9 (in the D2 direction) may be wider than the width of the elastic member 7, and edge portions may protrude from the three surfaces toward a −D2 side and/or a +D2 side. For example, the liquid retention member 9 may overlap the elastic member 7 only in regions of the main surfaces 7a on the side of the front end 3a and may expose regions of the main surfaces 7a on the side of the rear end 3b. For example, the liquid retention member 9 may overlap the side surface 7b on the side of the rear end 3b and/or the remaining two side surfaces 7b in addition to the three surfaces described above. For example, the liquid retention member 9 may overlap one main surface 7a and one side surface 7b (e.g., the side surface 7b on the side of the front end 3a), or may overlap the two main surfaces 7a and the side surfaces 7b other than the side surface 7b on the side of the front end 3a.

The thickness of the liquid retention member 9 may be set as appropriate. Note that, depending on the material of the liquid retention member 9, the thickness of the liquid retention member 9 may greatly change due to compression during wiping and/or absorption of liquid. In the description of the embodiment, unless otherwise specified, the thickness of the liquid retention member 9 refers to the thickness in a dry state with no force applied.

In the illustrated example, the thickness of the liquid retention member 9 is constant over the entirety thereof. However, the thickness of the liquid retention member 9 may vary from position to position. In the illustrated example, the thickness of the liquid retention member 9 is thinner than the thickness of the elastic member 7. In this case, the thickness of the liquid retention member 9 may be, for example, 1/20 or more and ⅓ or less of the thickness of the elastic member 7. However, unlike the illustrated example, the thickness of the liquid retention member 9 may be equal to or greater than the thickness of the elastic member 7. A relatively narrow range of the thickness of the liquid retention member 9 can be 0.1 mm or more and 1 mm or less.

The thickness of the liquid retention member 9 affects, for example, the amount of the cleaning liquid retained in the liquid retention member 9 and the contact pressure of the wiping member 3 against the discharge surface 1a. Consequently, the thickness of the liquid retention member 9 affects a cleaning effect by wiping. Therefore, the thickness of the liquid retention member 9 may be appropriately set (in other words, changed) according to various conditions related to wiping. The conditions to be considered in setting the thickness are, for example, at least one of the type of liquid (e.g., component of ink) discharged by the head 1, timings of wiping (which will be described later and frequency from another viewpoint), the type (component) of cleaning liquid, and the material of the liquid retention member 9.

The material of the liquid retention member 9 may be any of various materials capable of retaining liquid. For example, the material of the liquid retention member 9 may have flexibility or elasticity. In the description of the embodiment, the term “flexibility” refers to a property of being able to bend with little restoring force (elastic force) and does not include elasticity. Examples of materials having flexibility include cloth. As another material having flexibility or elasticity, for example, a porous medium can be exemplified.

The cloth may be woven or non-woven. To be stated for confirmation, the woven fabric is made, for example, by weaving fibers or yarns made of fibers (e.g., combining the warp and weft). The term “woven fabric” refers to a broad concept including knitting and the like. Non-woven fabrics are made by bonding or intertwining fibers, for example, by thermal, mechanical, and/or chemical treatments. In the woven fabric and the non-woven fabric, the fiber may be a natural fiber or a chemical fiber (in other words, an artificial fiber). Examples of natural fibers include, for example, cotton. Examples of the chemical fibers include polyester, nylon, acrylic, and polyurethane.

An example of the porous medium is a sponge. The sponge may be a natural sponge or an artificial sponge. The natural sponge can be made from a marine sponge. The artificial sponge can be obtained by foam-molding a synthetic resin such as polyurethane. The artificial sponge may also be made of vulcanized rubber.

Liquid retention properties (water retention properties) of the material of the liquid retention member 9 may be set as appropriate. For example, a value obtained by dividing a mass of water that the material can retain by a mass of the material and multiplying the quotient by 100 is referred to as a water retention rate (%). This water retention rate may be measured, for example, by a measurement method for a water absorption rate defined in JIS L1907 or a measurement method for a water retention rate defined in JIS L1913. At this time, the water retention rate may be 10% or more and 1000% or less, or 150% or more and 400% or less, or may be outside these ranges. For example, JIS L1907 defines the Byreck method for measuring a water absorption rate (mm) by measuring a length of rise of water absorbed by a sample of a predetermined size within a predetermined time. The water absorption rate of the material of the liquid retention member 9 measured by the Byreck method may be, for example, 1 mm or more and 200 mm or less, or 5 mm or more and 100 mm or less, or may be outside these ranges.

The amount of liquid that can be retained depending on the liquid retention properties of the material of the liquid retention member 9 and the thickness of the liquid retention member 9 may also be set as appropriate. As described above, the thickness of the liquid retention member 9 may be freely set within a wide range according to various circumstances, and the amount of liquid that can be retained may also be freely set within a wide range. As an example of a relatively narrow range, the amount of water that the liquid retention member 9 can retain may be 100 g/m² or more and 1000 g/m² or less.

Attachment Method for Attaching Liquid Retention Member) FIGS. 2A and 2B are side views or cross-sectional views illustrating an example of an attachment method for attaching the liquid retention member 9 to the elastic member 7.

FIG. 2A illustrates a state before attachment. FIG. 2B illustrates a state after attachment. In FIG. 2B, the liquid retention member 9 before attachment is also illustrated by fictitious outlines (long-dashed double-short-dashed lines).

The liquid retention member 9 is made of, for example, a material having flexibility (e.g., cloth). In other words, the liquid retention member 9 does not have a specific three dimensional shape obtained by a restoring force. The liquid retention member 9 overlaps the surfaces of the elastic member 7 and has a shape corresponding to the shape of the elastic member 7. In this state, the liquid retention member 9 is fixed to the elastic member 7. The liquid retention member 9 may or may not be under tension when fixed to the elastic member 7. The size of the liquid retention member 9 under tension can be set freely, and slackness of the liquid retention member 9 in a non-tensioned state can be set freely.

Unlike the above description, the liquid retention member 9 may be made of a material having elasticity (e.g., a sponge having elasticity). In this case, for example, when no restoring force is generated, the liquid retention member 9 has a shape that is more developed (e.g., a flat plate shape) than the shape when attached to the elastic member 7. The liquid retention member 9 is then bent to fit the surface shape of the elastic member 7 and overlapped on the surfaces of the elastic member 7. In this state, the liquid retention member 9 is fixed to the elastic member 7. Whether tension is applied to the liquid retention member 9 can be selected as in the case in which the liquid retention member 9 has flexibility.

In the illustrated example, the liquid retention member 9 can be regarded as being wrapped around the elastic member 7. When the liquid retention member 9 is described as being wrapped around the elastic member 7, the liquid retention member 9 may have flexibility as described above, or may have elasticity such that the liquid retention member 9 is in a developed shape when no restoring force is generated. When the liquid retention member 9 is described as being wrapped around the elastic member 7, for example, the liquid retention member 9 extends over at least two surfaces facing opposite sides (and a surface therebetween). In the illustrated example, the liquid retention member 9 extends over the two main surfaces 7a (partially or entirely) and the one side surface 7b (partially or entirely). Whether tension is applied to the liquid retention member 9 when described as being wrapped is optional.

A fixation method for suppressing the liquid retention member 9 from falling off from the elastic member 7 may be determined to be appropriate. For example, the liquid retention member 9 may be detachable from the elastic member 7 or may not be detachable. The entire portion of the liquid retention member 9 overlapping the elastic member 7 may be fixed to the elastic member 7, or only part of the portion of the liquid retention member 9 overlapping the elastic member 7 may be fixed to the elastic member 7. Examples of the latter, for example, include a method in which only portions of the liquid retention member 9 on the side of the rear end 3b are fixed to the elastic member 7. In this method, displacement of the liquid retention member 9 with respect to the elastic member 7 may or may not be restricted by being in contact with portions of the elastic member 7 on the side of the front end 3a while exerting tension.

Examples of a method of detachable fixation include a method in which a member is used that holds the portions of the wiping member 3 on the side of the rear end 3b (described later) so as to press the liquid retention member 9 against the elastic member 7. Although not illustrated, examples of a method of detachable fixation include a method in which a detachable member is used that is detachably attached to a predetermined portion of the wiping member 3 so as to press the liquid retention member 9 against the elastic member 7. Examples of the detachable members include fastening members (screws and/or nuts), a member that uses fastening members, a member that uses engagement, and a member that tightens the elastic member 7 using a restoring force of the elastic member 7 or the detachable member.

Examples of a non-detachable fixation method include a method in which an adhesive is interposed between the liquid retention member 9 and the elastic member 7. Examples of a non-detachable fixing method also include a method in which the liquid retention member 9 and/or the elastic member 7 is melted and the liquid retention member 9 and the elastic member 7 are adhered. Such non-detachable fixing methods may be used in either to fix the entire liquid retention member 9 to the elastic member 7 or to fix the liquid retention member 9 to the elastic member 7.

The shape of the elastic member 7 is, for example, the same, and/or similar before and after the liquid retention member 9 is attached. However, the elastic member 7 may be elastically deformed slightly due to force associated with attachment of the liquid retention member 9. For example, the elastic member 7 may undergo elastic deformation that has little effect on a wiping action. Examples of the force that causes elastic deformation include tension of the liquid retention member 9 wrapped around the elastic member 7, a force of a member holding the elastic member 7 or a member attached to and detached from the elastic member 7 pressing the liquid retention member 9 against the elastic member 7, or a force associated with curing shrinkage of an adhesive. Note that, in the description of the shape of the wiping member 3 and the shape of the elastic member 7, such slight elastic deformation is ignored. Unlike the examples described or illustrated above, the elastic member 7 may be elastically deformed to affect wiping. For example, when the wiping member 3 is not pressed against the discharge surface 1a, the elastic member 7 may deflect toward the +D1 side or the −D1 side due to the tension of the liquid retention member 9.

Variations of Attachment Method for Attaching Liquid Retention Member Several variations of the attachment method for attaching the liquid retention member 9 to the elastic member 7 will be described below.

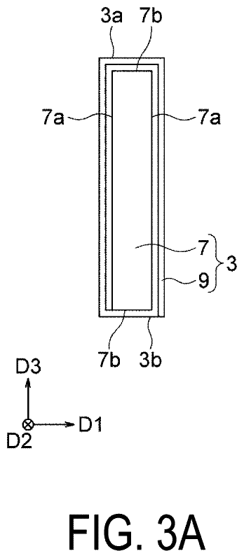

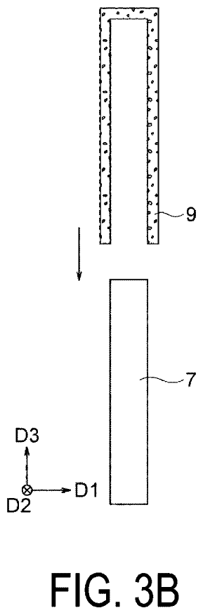

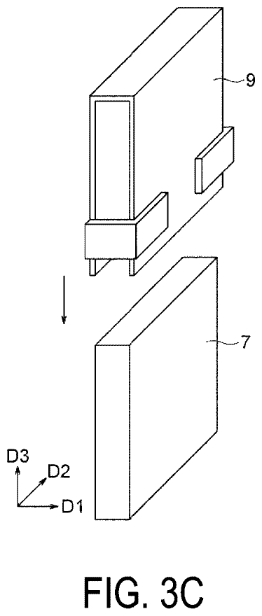

FIG. 3A is a side view or cross-sectional view illustrating an attachment method according to a variation.

The attachment method according to the variation is an attachment method in which the liquid retention member 9 is wrapped around the elastic member 7 as in the embodiment (FIGS. 2A and 2B). However, while in the embodiment, the liquid retention member 9 is not wrapped around the elastic member 7 one turn, in the variation, the liquid retention member 9 is wrapped around the elastic member 7 one turn or more. In the illustrated example, the liquid retention member 9 is further wrapped around at least one of the surfaces of the elastic member 7 used for wiping at least two turns. In more detail, the liquid retention member 9 has at least two layers (two layers in the illustrated example) on three surfaces: the two main surfaces 7a and the side surface 7b on the side of the front end 3a. Note that in the two-layered portion, portions of the liquid retention member 9 may be fixed to each other with an adhesive or the like, or need not be fixed.

FIG. 3B is a side view or cross-sectional view illustrating an attachment method according to another variation.

In the attachment method according to this variation, the material of the liquid retention member 9 is assumed to have elasticity (e.g., sponge). The shape of the liquid retention member 9 when the liquid retention member 9 is not elastically deformed is substantially the same as, and/or similar to the shape after being attached to the elastic member 7. The liquid retention member 9 is then attached to the elastic member 7 so as to cover the elastic member 7. That is, the variation illustrated in FIG. 3B differs from the previous variation in that the liquid retention member 9 is not wrapped around the elastic member 7.

An inner surface of the liquid retention member 9 may have, for example, the same shape and dimensions as an outer surface of the elastic member 7 (a region of the outer surface where the liquid retention member 9 overlaps. Hereinafter, the same, and/or similar in this paragraph). After being attached to the elastic member 7, the liquid retention member 9 does not need to be elastically deformed at all. Unlike the above, the inner surface of the liquid retention member 9 may be partially or entirely smaller than the outer surface of the elastic member 7. Then, after being attached to the elastic member 7, the liquid retention member 9 may generate an inward restoring force to tighten the elastic member 7. On the contrary, the inner surface of the liquid retention member 9 may be partially or entirely larger than the outer surface of the elastic member 7.

FIG. 3C is a perspective view illustrating an attachment method according to still another variation.

In the attachment method according to this variation, the material of the liquid retention member 9 is assumed to have flexibility (e.g., cloth). However, the liquid retention member 9 is formed into a bag shape or a shape similar to a bag by fixing portions of the liquid retention member 9 in a non-detachable manner. Then, instead of wrapping the liquid retention member 9 around the elastic member 7, the liquid retention member 9 covers the elastic member 7. Examples of means for non-detachably fixing the portions of the liquid retention member 9 include sewing and adhesion.

Note that, unlike the above description, the fixation of portions of the liquid retention member 9 in FIG. 3C may be detachable. Examples of such fixing means include hook-and-loop fasteners, buttons, and hooks. In this case, since the liquid retention member 9 is wrapped and then the portions of the liquid retention member 9 can be fixed, the liquid retention member 9 may be regarded as being wrapped around the elastic member 7.

Although not illustrated, instead of being wrapped around the elastic member 7 around an axis along the D2 direction, the liquid retention member 9 may be wrapped around the elastic member 7 around an axis along another direction. For example, the liquid retention member 9 may be wrapped around the elastic member 7 around an axis along the D3 direction to expose the side surface 7b on the +D3 side (the side of the front end 3a) while covering the two main surfaces 7a. Instead of covering the elastic member 7 from the +D3 side, the liquid retention member 9 may cover the elastic member 7 from any of five other directions. In this case, the side surface 7b on the +D3 side may be covered with the liquid retention member 9 or may be exposed.

In the attachment methods according to the several variations described above, the fixation method for suppressing the liquid retention member 9 from falling off from the elastic member 7 may be the same as, and/or similar to that in the embodiment.

Variations of Shape of Elastic Member

Several variations of the shape of the elastic member 7 (wiping member 3) will be described below.

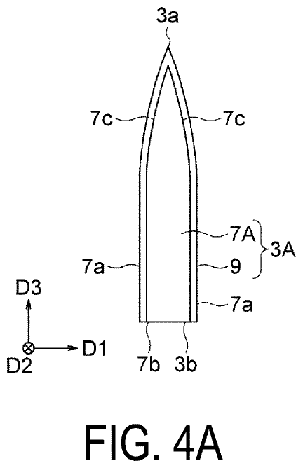

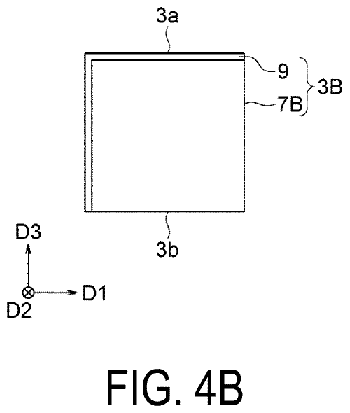

FIG. 4A is a side view or a cross-sectional view illustrating a wiping member 3A according to a variation.

The same as, and/or similar to the elastic member 7 according to the embodiment, an elastic member 7A of the wiping member 3A is plate-like on the whole and includes two main surfaces 7a facing opposite sides. However, the elastic member 7A is formed so as to be thinner toward the side of the front end 3a, and does not include the side surface 7b on the side of the front end 3a. For example, the liquid retention member 9 overlaps the elastic member 7A over the two main surfaces 7a so as to cover an end portion on the +D3 side of the elastic member 7A.

In such an aspect, it may be understood that each main surface 7a includes an inclined surface 7c and that the two main surfaces 7a connect (intersect) with each other. In such a case, it can be said that the liquid retention member 9 overlaps the elastic member 7 over two surfaces facing in different directions (in more detail, opposite directions). Unlike the above, it may be understood that the inclined surfaces 7c (different from the main surfaces 7a) are connected to respective ones of the main surfaces 7a on the side of the front end 3a, and the two inclined surfaces 7c are connected to each other. In such a case, it can also be said that the liquid retention member 9 overlaps the elastic member 7 over two surfaces (two inclined surfaces 7c or two main surfaces 7a) facing in different directions (in more detail, opposite directions).

When the inclined surface 7c and the main surface 7a are regarded as separate surfaces, although not illustrated, the liquid retention member 9 may overlap the two inclined surfaces 7c and need not overlap the main surfaces 7a. For example, the elastic member 7A may not include the main surfaces 7a, and the inclined surfaces 7c and the side surface 7b on the −D3 side may be connected. That is, the elastic member 7A may have a substantially triangular shape when viewed from a side. The liquid retention member 9 may then overlap the two inclined surfaces 7c. Even in these cases, it can be said that the liquid retention member 9 overlaps the elastic member 7 over the two surfaces (two inclined surfaces 7c) facing in different directions (in more detail, opposite directions).

As will be appreciated from the above description, the two surfaces facing opposite sides need not be parallel to each other. For example, when an angle formed by two surfaces that are not parallel to each other (the two surfaces themselves or virtual surfaces extending outward from the two surfaces) is less than 90°, less than 80°, less than 60°, or less than 30°, these two surfaces may be considered to face in opposite directions. Although not illustrated, unlike the illustrated example, the angle formed by the two inclined surfaces 7c may be an angle that does not imply that the two inclined surfaces face opposite sides (e.g., 90° or more).

As can be understood from the shape of the elastic member 7A, the thickness of the elastic member may vary from portion to portion. For example, although not illustrated, the thickness of the elastic member may differ between a portion assumed to be in contact with the discharge surface 1a and a portion not assumed to be in contact with the discharge surface 1a. In this case, either one may be thinner than the other. The thickness of the elastic member may differ between a portion where deflection is restricted by being held by support members to be described later and a portion where deflection is not restricted by not being held. In this case, either one may be thinner than the other. At a boundary between portions having different thicknesses, the thickness may gradually change so as not to produce a step, or a step may be formed.

FIG. 4B is a side view or a cross-sectional view illustrating a wiping member 3B according to another variation.

As illustrated by an elastic member 7B in this figure, the elastic member need not be plate-like. In the illustrated example, the elastic member 7B is substantially square when viewed in the D2 direction. As illustrated in this figure, when the liquid retention member 9 overlaps the elastic member over two or more surfaces, the two or more surfaces need not include two surfaces facing opposite sides. In the illustrated example, the liquid retention member 9 overlaps only a surface of the elastic member 7B on the +D3 side (the side of the front end 3a) and a surface of the elastic member 7B on the −D1 side. From another point of view, the liquid retention member 9 is asymmetric with respect to an axis parallel to the D3 direction when viewed in the D2 direction.

In a wiping member such as the wiping member 3B in which the liquid retention member 9 and the like are asymmetric, a specific effect of the liquid retention member 9 differs between wiping by moving to the −D1 side and wiping by moving to the +D1 side. The asymmetric wiping member may be used only for wiping by moving to the −D1 side, may be used only for wiping by moving to the +D1 side, or may be used for wiping by moving both sides.

Although not illustrated, various shapes in addition to those exemplified above can be employed for the shape of the elastic member. For example, an end portion of the elastic member on the +D3 side may be arc-shaped (in a broader concept, a shape curved outward) when viewed in the D2 direction. In such a case, the curved surface and another surface (e.g., the flat main surface 7a) may be regarded as two surfaces facing in different directions. When a central angle of the curve (arc) is relatively large, the curved surface may be considered to include two or more surfaces. For example, a virtual plane in contact with one position on the curved surface and a virtual plane in contact with another position on the curved surface are considered. When the virtual planes are parallel to each other, or when an angle formed by the virtual planes is within the range of the angle formed by the two surfaces facing in opposite directions described above (less than 90°, less than 80°, less than 60°, or less than 30°), the curved surface may be considered to include the two surfaces facing opposite each other. The elastic member may be plate-like, including a curved portion (a portion bent in a curved shape) and/or a bent portion (a portion bent while forming a corner portion) when viewed in the D2 direction.

Holding Unit for Holding Wiping Member

A configuration of a holding unit that holds the wiping member 3 may be adopted from various configurations, and may be, for example, the same as, and/or similar to a known configuration. Examples of novel configurations will be described below. Note that matters not described may be the same as, and/or similar to various known configurations. A configuration including the wiping member 3 and the holding unit may be referred to as a wiper.

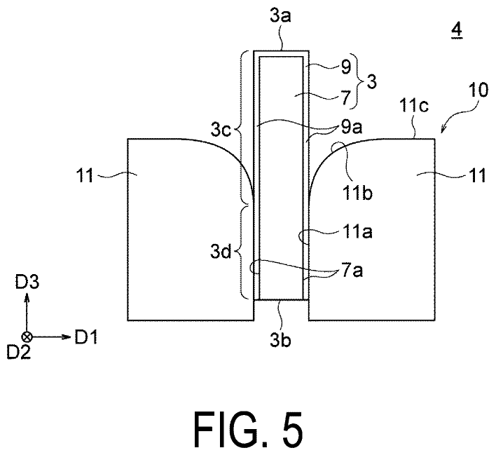

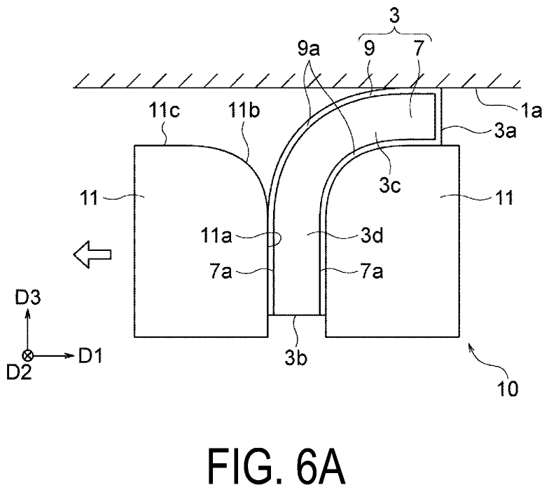

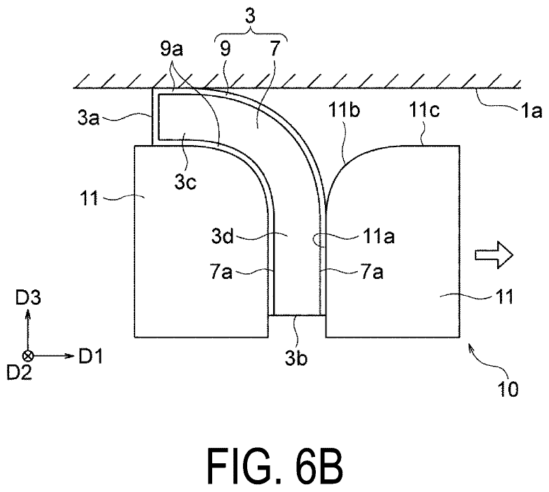

FIGS. 5, 6A, and 6B are side views or cross-sectional views illustrating the wiping member 3 and the holding unit 10 (wiper 4).

FIG. 5 illustrates a state in which wiping is not performed (a state in which the wiping member 3 is not elastically deformed). FIG. 6A illustrates an example of a state in which the wiping member 3 is moved to the −D1 side to perform wiping. FIG. 6B illustrates an example of a state in which the wiping member 3 is moved to the +D1 side to perform wiping. The shapes illustrated in these figures, for example, extend over substantially an entire length of at least the wiping member 3 in the D2 direction. However, a portion different from the illustrated shape may exist.

The holding unit 10 includes two support members 11. In the illustrated example, the two support members 11 have the same shape. The two support members 11 sandwich the wiping member 3 in the D2 direction. Thus, the wiping member 3 is held by the holding unit 10. Although not illustrated, the holding unit 10 may include a member that supports the wiping member 3 in addition to the support members 11. Examples of such a member include a member that is in contact with the wiping member 3 from the +D2 side or the −D2 side, a member that is in contact with the wiping member 3 from the −D3 side, and a member that penetrates the wiping member 3. These members may be configured as one member with the support members 11. The pressure with which the support members 11 compress the wiping member 3 in the D1 direction may be set as appropriate. Note that the two support members 11 do not need to compress the wiping member 3. In this case, the wiping member 3 may be suppressed from falling off by a member other than the support members 11 described above.

In more detail, the two support members 11 sandwich a portion of the wiping member 3 on the side of the rear end 3b. A portion of the wiping member 3 on the side of the front end 3a protrudes to the +D3 side from the two support members 11, allowing deflection (e.g., deflection in the D1 direction) with the front end 3a as a free end. From another viewpoint, the wiping member 3 includes a body portion 3c including the front end 3a, and a held portion 3d located closer to the rear end 3b than the body portion 3c. The support member 11 on the +D1 side includes a holding surface 11a that is in contact with the held portion 3d from a side that the main surface 7a on the +D1 side faces. The holding surface 11a allows deflection of the body portion 3c toward the side that the main surface 7a on the +D1 side faces. The same applies to the support member 11 on the −D1 side, except that D1 is negative instead of positive.

The shape of the holding surface 11a can be set freely. In the illustrated example, the holding surface 11a has a flat shape. However, the holding surface 11a may have a curved shape or may have protrusions and recesses. The protrusions and recesses bite into the flat surfaces of the held portion 3d on the +D1 side and/or the −D1 side, thereby contributing to reducing the probability that the held portion 3d slips on the holding surfaces 11a. In an aspect in which the held portion 3d has protrusions and/or recesses for engagement on the surfaces on the +D1 side and/or the −D1 side, recesses and/or protrusions that engage with the protrusions and/or recesses may be provided on the holding surface 11a.

The dimensions of the holding surface 11a can be set freely. For example, the length of the holding surface 11a being in contact with the wiping member 3 in the D3 direction (in other words, a direction from the front end 3a to the rear end 3b along the main surface 7a) may be set as appropriate. From another point of view, one of a length of the body portion 3c in the D3 direction and a length of the held portion 3d in the D3 direction may be longer than or equal to the other. In the illustrated example, the length of the body portion 3c in the D3 direction is longer than the length of the held portion 3d in the D3 direction. In the illustrated example, the holding surface 11a extends beyond the rear end 3b of the wiping member 3 to the −D3 side. Unlike the illustrated example, an edge portion of the holding surface 11a on the −D3 side may coincide with the rear end 3b, or may not reach the rear end 3b, allowing the rear end 3b to protrude. In the D2 direction, the length of the holding surface 11a (the same applies to other surfaces described later) may be longer than, equal to, or shorter than the length of the wiping member 3.

In the illustrated example, the holding surface 11a is in contact with the liquid retention member 9. From another point of view, the liquid retention member 9 is provided over the body portion 3c and the held portion 3d in the D3 direction (in other words, the direction from the front end 3a to the rear end 3b along the main surface 7a). Unlike the illustrated example, the liquid retention member 9 may be located only on the body portion 3c (all or part thereof) in the D3 direction, or may be located on the entirety of the body portion 3c and part of the held portion 3d. That is, the holding surface 11a may be in contact with the elastic member 7 or may be in contact with both the elastic member 7 and the liquid retention member 9.

The shape and dimensions of the surface of the support member 11 on the +D3 side with respect to the holding surface 11a can be set freely. In the illustrated example, the support member 11 includes a convex curved surface 11b connected to the holding surface 11a and a front end surface 11c connected to the convex curved surface 11b. These surfaces may, for example, contribute to pressing the body portion 3c. This pressing, for example, can push out the cleaning liquid that has permeated a portion of the liquid retention member 9 located on the body portion 3c, or press the body portion 3c against the discharge surface 1a. Of course, the convex curved surface 11b and/or the front end surface 11c need not be used to press the body portion 3c.

The convex curved surface 11b is connected to the holding surface 11a on the side of the front end 3a. The convex curved surface 11b is, as its name suggests, a convex curved surface. In other words, the convex curved surface 11b of the support member 11 on the +D1 side is curved away from the wiping member 3 in a non-deflected state toward the +D1 side (the side that the main surface 7a on the +D1 side faces) as the convex curved surface 11b is located closer to the front end 3a (the +D3 side). The same applies to the convex curved surface 11b of the support member 11 on the −D1 side, except that the D1 is negative instead of positive.

The specific shape of the convex curved surface 11b in the D1-D3 section can be set freely. For example, the convex curved surface 11b may have a constant curvature over the entire length thereof (i.e., may be an arc) as in the illustrated example, or may have a curvature that varies from position to position, unlike the illustrated example. The convex curved surface 11b may be smoothly connected to the holding surface 11a and/or the front end surface 11c so as not to form corners with the holding surface 11a and/or the front end surface 11c (the illustrated example), or may form corners. In other words, a normal line of an end portion of the convex curved surface 11b on the −D3 side may or may not be parallel to the D1 direction, and a normal line of an end portion of the convex curved surface 11b on the +D3 side may or may not be parallel to the D3 direction.

The dimensions of the convex curved surface 11b in the D1-D3 section may be set as appropriate. For example, a curvature of the convex curved surface 11b can be set freely. For example, when a radius of curvature is relatively large (the curvature is relatively small), the radius of curvature may be 1/10 or more, ⅕ or more, or ⅓ or more of the length of the body portion 3c of the wiping member 3. The length along the surface of the convex curved surface 11b is shorter than the length of the body portion 3c of the wiping member 3. However, the former may be equal to or less than the latter.

The specific shape and dimensions of the front end surface 11c in the D1-D3 section can be set freely. For example, in the illustrated example, the front end surface 11c has a flat surface shape parallel to the discharge surface 1a. However, the front end surface 11c may be convex or concave on the whole, may have protrusions and recesses, or may be inclined with respect to the discharge surface 1a. The length of the front end surface 11c may be shorter than, equal to, or longer than the length of the convex curved surface 11b. When the entire wiping member 3 is in close contact with the support member 11 as illustrated in FIGS. 6A and 6B, an edge portion of the front end surface 11c on the opposite side to the convex curved surface 11b may be located farther from the convex curved surface 11b than the front end 3a of the wiping member 3 (the illustrated example), may coincide with the front end 3a, or may be located closer to the convex curved surface 11b than the front end 3a.

Variation of Holding Unit

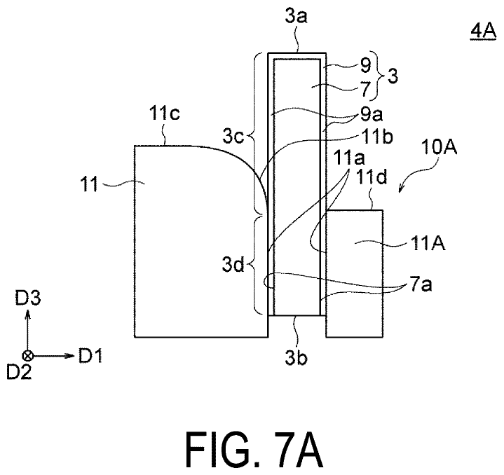

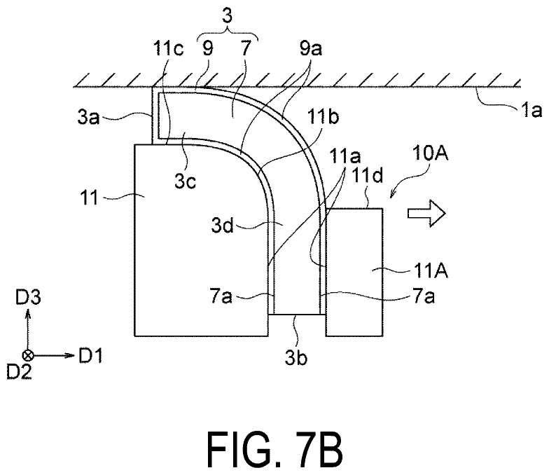

FIGS. 7A and 7B are side views or cross-sectional views illustrating a configuration of a holding unit 10A (from another viewpoint, a wiper 4A) according to a variation.

FIG. 7A illustrates a state in which wiping is not performed (a state in which the wiping member 3 is not elastically deformed). FIG. 7B illustrates an example of a state in which the wiping member 3 is moved to the +D1 side to perform wiping.

A holding unit 10A includes the support member 11 described above and a support member 11A according to the variation having a shape different from that of the support member 11. The wiping member 3 is sandwiched between the support member 11 and the support member 11A. From another viewpoint, the holding unit 10A has an asymmetric shape with respect to the wiping member 3 when viewed in the D2 direction. In this variation, for example, only wiping by moving the wiping member 3 to the +D1 side is performed, and wiping by moving the wiping member 3 to the −D1 side is not assumed. Although not illustrated, of course, the positional relationship between the support member 11 and the support member 11A in the D1 direction may be reversed, and in this case, wiping may be performed by moving to the −D1 side.

For example, the support member 11A has a shape that does not need to have a function of pressing the body portion 3c of the wiping member 3 during wiping. To be specific, the support member 11A includes the holding surface 11a and a front end surface 11d intersecting the holding surface 11a. That is, the support member 11A does not include the convex curved surface 11b. The front end surface 11d is located on the −D3 side of the front end surface 11c of the support member 11.

The description of the holding surface 11a of the support member 11 may be applied to the holding surface 11a of the support member 11A. Unlike the illustrated example, an upper edge of a surface of the support member 11A facing the −D1 side (the surface including the holding surface 11a) may be located above the held portion 3d of the wiping member 3. Even in this case, since the convex curved surface 11b of the support member 11 is curved in a direction away from the wiping member 3 in a non-elastically deformed state, a surface area in which the held portion 3d is substantially held does not change.

Since the front end surface 11d is not assumed to be in contact with the wiping member 3, the front end surface 11d may have any shape and dimensions. In the illustrated example, the front end surface 11d has a flat surface shape parallel to the discharge surface 1a.

Various shapes and dimensions of the support member are possible other than those described above. Although not illustrated, for example, in an aspect in which the front end surface 11c is assumed to press the wiping member 3 as in the embodiment, the holding surface 11a and the front end surface 11c may intersect without providing the convex curved surface 11b. Instead of the convex curved surface 11b, a flat inclined surface may be provided that chamfers a corner portion of the holding surface 11a and the front end surface 11c (or the front end surface 11d). A surface connecting the holding surface 11a and the front end surface 11c (or the front end surface 11d) may have a convex curved surface and an inclined surface, or may have two or more inclined surfaces having different angles when viewed in the D2 direction.

For example, in an aspect in which both wiping by moving to the −D1 side and wiping by moving to the +D1 side are assumed, the support member on the −D1 side and the support member on the +D1 side may have different shapes and/or dimensions. For example, the curvature and/or length of the convex curved surface 11b may be different between the support member 11 on the −D1 side and the support member 11 on the +D1 side. The holding unit 10A according to the variation has been described as being used for wiping by moving to the +D1 side, but may be used for wiping by moving to the −D1 side in addition to or instead of wiping by moving to the +D1 side.

In the above description of the holding unit (and the support members), the wiping member 3 illustrated in FIG. 1 is taken as an example among the various wiping members described above. However, any wiping member among the various wiping members may be combined with the support unit described above. For example, regarding the symmetry when viewed in the D2 direction, a combination of the wiping member and the holding unit may be symmetric-symmetric (e.g., FIG. 5) or symmetric-asymmetric (e.g., FIG. 7A). The combination regarding symmetry may be asymmetric-symmetric. For example, the wiping member 3B illustrated in FIG. 4B may be combined with the holding unit 10 illustrated in FIG. 5. The combination regarding symmetry may be asymmetric-asymmetric. For example, the wiping member 3B illustrated in FIG. 4B may be combined with the holding unit 10A illustrated in FIG. 7A.

Fixation of Two Support Members

The two support members 11 may be fixed to each other so as to sandwich and hold the wiping member 3 (in other words, to tighten the wiping member 3). There are various fixation methods. Some examples will be given below.

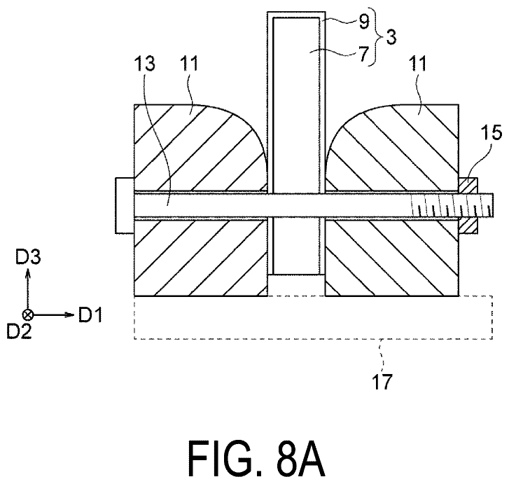

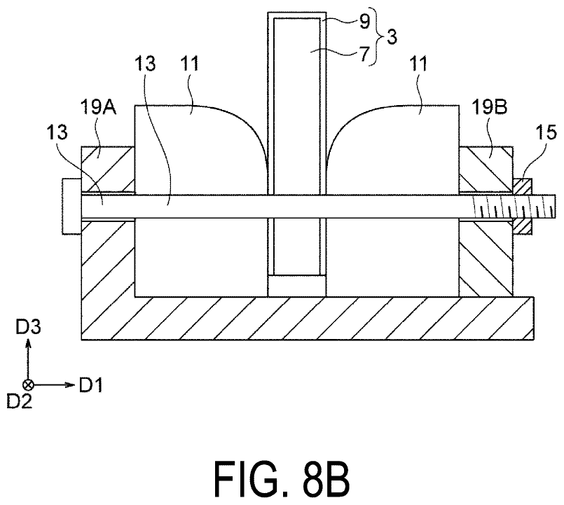

FIG. 8A is a cross-sectional view illustrating an example of a fixation method for fixing the two support members 11.

In this example, a bolt 13 is inserted through the two support members 11 in the D1 direction, and a nut 15 is screwed onto the bolt 13. Thus, the two support members 11 are fixed to each other so as to tighten the wiping member 3 in the D1 direction. The number and specific positions of combinations of the bolts 13 and the nuts 15 can be set freely. In the illustrated example, the length of the support members 11 is longer than the length of the wiping member 3 in the D2 direction. The bolt 13 and the nut 15 located on the −D2 side (front side in the figure) with respect to the wiping member 3 are illustrated. The bolt 13 and the nut 15 may also be provided on the +D2 side with respect to the wiping member 3.

Although not illustrated, unlike the illustrated example, the bolt 13 may pass through the wiping member 3 and directly contribute to positioning of the wiping member 3. The bolt 13 may be positioned below the wiping member 3. Instead of providing the nut 15, a female screw into which the bolt 13 is screwed may be provided in one of the support members 11. As indicated by dotted lines, one of the support members 11 (the support member 11 on the −D1 side in the illustrated example) may include a placement portion 17 on which the other support member 11 is placed. Two of the support members 11 may be connected to each other on the −D3 side. In this case, by tightening the bolt 13, portions of the two support members 11 on the −D3 side may be elastically deformed so that the two support members 11 tighten the wiping member 3. One support member 11 may include wall portions that position the other support member 11 from the +D2 side and/or the −D2 side.

FIG. 8B is a cross-sectional view illustrating another example of a fixation method for fixing the two support members 11.

In this example, the bolt 13 and the nut 15 do not directly fix the two support members 11, but fix the two support members 11 with two fixing members 19A and 19B interposed therebetween. To be specific, the two fixing members 19A and 19B are disposed on both sides of the two support members 11 in the D1 direction. The bolt 13 is inserted through the fixing members 19A and 19B in the D1 direction, and the nut 15 is screwed onto the bolt 13. Thus, the two support members 11 are fixed to each other so as to tighten the wiping member 3 in the D1 direction.

The shapes of the fixing members 19A and 19B can be set freely. In the illustrated example, the fixing member 19A includes a placement portion (reference sign omitted) on which the two support members 11 and the fixing member 19B are placed. Although not illustrated, the fixing member 19A may include wall portions that position the two support members 11 and the fixing member 19B from the +D2 side and/or the −D2 side. The number and specific positions of combinations of the bolts 13 and the nuts 15 can be set freely. In the illustrated example, the bolt 13 and the nut 15 positioned on the −D2 side (front side in the figure) with respect to the wiping member 3 and the support members 11 are illustrated. The bolt 13 and the nut 15 may also be provided on the +D2 side with respect to the wiping member 3.

Although not illustrated, unlike the illustrated example, the bolt 13 may pass through the support members 11 and/or the wiping member 3. The bolt 13 may be positioned below the wiping member 3. Instead of providing the nut 15, a female screw into which the bolt 13 is screwed may be provided in the fixing member 19B. The nut 15 may be in contact with the support member 11 without providing the fixing member 19B.

Wiping Operation

Various methods may be adopted for wiping operation by the wiping member 3. For example, the wiping operation may be the same as, and/or similar to any known operation. The following are examples of various types of operation, including novel types of operation.

Contact State of Wiping

As illustrated in FIGS. 6A, 6B, and 7B, when wiping is performed (from another viewpoint, when the wiping member 3 is moved in the D2 direction), the main surface (the widest surface with the plate shape as described above) of the wiping member 3 may be in contact (in more detail, surface contact) with the discharge surface 1a. In more detail, for example, at least part of the body portion 3c of the wiping member 3 may be sandwiched (e.g., compressed) between the discharge surface 1a and the support member 11 (in more detail, the front end surface 11c). However, unlike the illustrated example, the main surface of the body portion 3c may be in surface contact with the discharge surface 1a while the body portion 3c is not sandwiched between the discharge surface 1a and the front end surface 11c.

In the case of surface contact as described above, when viewed in the D2 direction, a length of the main surface of the body portion 3c in contact with the discharge surface 1a (or the front end surface 11c) in the D1 direction can be set freely. For example, this length may be ½ or more, one time or more, or two times or more the thickness of the wiping member 3 or the thickness of the elastic member 7. A length of the main surface 7a of the elastic member 7 parallel to the discharge surface 1a (D1 direction) may satisfy the above range. A compressive force applied to the wiping member 3 by the discharge surface 1a and the support member 11 can also be set freely.

Portions of the liquid retention member 9 that are located on the body portion 3c and on the main surfaces 7a of the elastic member 7 are referred to as liquid retention bodies 9a. In the examples illustrated in FIGS. 6A, 6B, and 7B, one liquid retention body 9a of the two liquid retention bodies 9a is in surface contact with the discharge surface 1a. The liquid retention body 9a in surface contact with the discharge surface 1a is pressed toward the discharge surface 1a by the elastic member 7. The other liquid retention body 9a is pressed toward the elastic member 7 by the support member 11 (in more detail, the convex curved surface 11b and the front end surface 11c). Such pressing may contribute to squeezing out the cleaning liquid retained in the liquid retention body 9a.

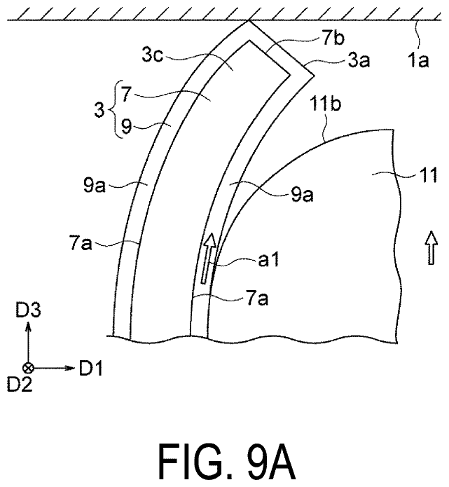

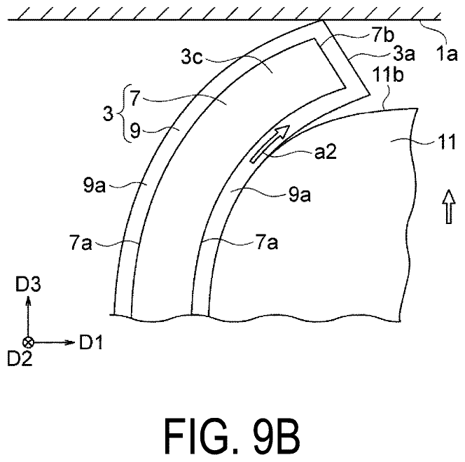

FIGS. 9A and 9B are side views or cross-sectional views illustrating examples of other states of the wiping member 3.

In FIGS. 9A and 9B, the convex curved surface 11b of the support member 11 and surroundings thereof are illustrated enlarged. The support member 11 on the −D1 side is not illustrated. For the sake of convenience, the wiping member 3 is depicted to be shorter than in FIG. 5 and others, and does not include a portion that overlaps the front end surface 11c (not illustrated here). Note that in practice, the wiping member 3 need not include the portion that overlaps the front end surface 11c as illustrated in the figures.

In the examples illustrated in FIGS. 9A and 9B, when viewed in the D2 direction, only part of the convex curved surface 11b on the side of the holding surface 11a (−D3 side) is in contact with (from another viewpoint, presses) the wiping member 3 (in more detail, the liquid retention body 9a). From another viewpoint, a surface area in which the convex curved surface 11b presses the liquid retention body 9a increases in the order of FIGS. 9A, 9B, and 6A. In these figures, assuming that the configuration of the wiping member 3 and the like is the same, a distance from the support member 11 to the discharge surface 1a (in the D3 direction) is longer in the order of FIGS. 9A, 9B, and 6A. From another point of view, the force with which the wiping member 3 is pressed toward the discharge surface 1a is smaller in the order of FIGS. 9A, 9B, and 6A.

FIGS. 6A, 9A, and 9B may be regarded as views illustrating different wiping operation methods, or may be regarded as different states that occur in one operation method. In the former case, for example, the wiping member 3 moves to the −D1 side while maintaining the states illustrated in FIGS. 6A, 9A, and 9B. In the latter case, for example, the wiping member 3 sequentially changes to two or more states illustrated in FIGS. 6A, 9A, and 9B while moving to the −D1 side. For example, the state of the wiping member 3 may change in the order of FIGS. 9A, 9B, and 6A.

An example of flow of the cleaning liquid in the liquid retention member 9 when the state of the wiping member 3 changes in the order of FIGS. 9A, 9B, and 6A will be described below. In FIG. 9A, a portion of the liquid retention body 9a where an arrow a1 is drawn is pressed by the convex curved surface 11b, whereby the cleaning liquid retained in this portion is squeezed out toward the side of the front end 3a. Subsequently, as illustrated in FIG. 9B, a portion where an arrow a2 is drawn is pressed by the convex curved surface 11b, whereby the cleaning liquid retained in this portion is squeezed out toward the side of the front end 3a. Note that during this period, the portion where the arrow a1 is drawn in FIG. 9A is pressed first, so probability that the cleaning liquid squeezed out from the portion where the arrow a2 is drawn moves toward the side of the rear end 3b is low. By such actions, the cleaning liquid retained in the liquid retention body 9a is squeezed out sequentially from the side of the rear end 3b to the side of the front end 3a. As a result, for example, the cleaning liquid can be squeezed out over a long travel distance in the D1 direction.

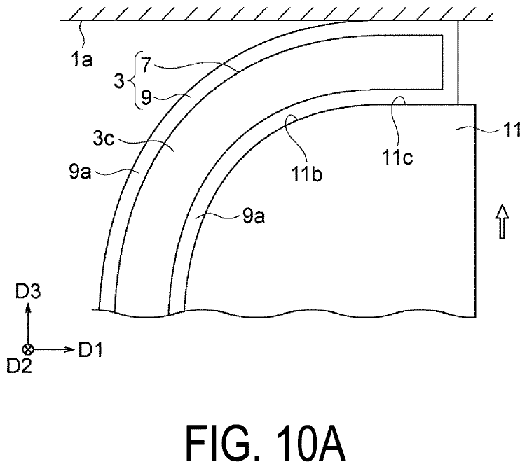

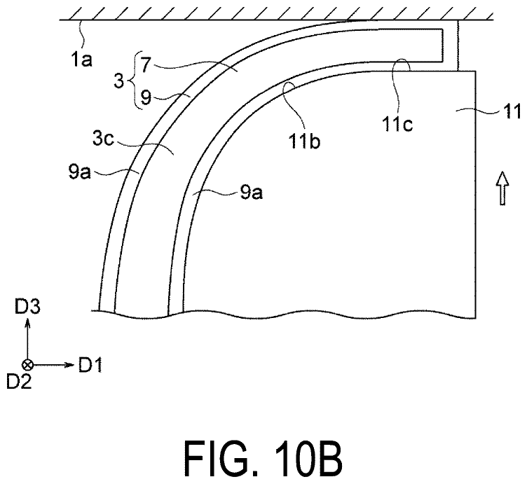

FIGS. 10A and 10B are side views or cross-sectional views illustrating examples of still other states of the wiping member 3.

FIG. 10A corresponds to a partially enlarged view of FIG. 6A. FIG. 10B is a view corresponding to FIG. 10A, illustrating a state different from that in FIG. 10A. In these figures, the support member 11 on the −D1 side is not illustrated.

With reference to FIGS. 6A, 9A, and 9B, it has been described that the different wiping operation methods or multiple states in which the forces with which the wiping member 3 is pressed toward the discharge surface 1a (from another viewpoint, the distance from the support member 11 to the discharge surface 1a) are different from each other in one operation method may be achieved. The states in which the pressing forces are different from each other may be achieved in states in which the wiping member 3 is sandwiched between the discharge surface 1a and the support member 11 as illustrated in FIGS. 10A and 10B.

To be more specific, the pressing force is greater in the state illustrated in FIG. 10B than in the state illustrated in FIG. 10A. When these two states occur in one wiping operation method, for example, these states may occur in the order illustrated in FIGS. 10A and 10B. In this case, for example, the cleaning liquid remaining in the liquid retention body 9a in the state illustrated in FIG. 10A is squeezed out when the state is in illustrated in FIG. 10B. As a result, for example, the cleaning liquid can be squeezed out over a long travel distance in the D1 direction.

Operation Procedure of Wiping

The contact states of the wiping member 3 described above may be achieved at appropriate timings Some examples are given below.

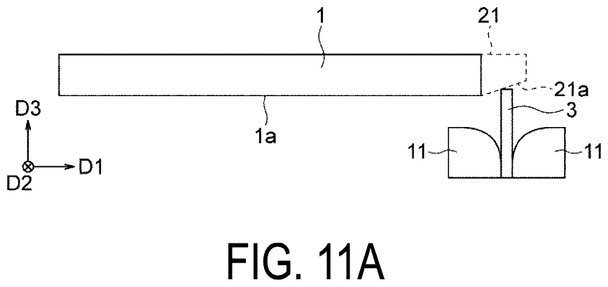

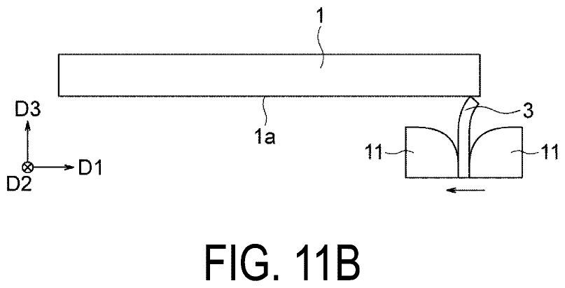

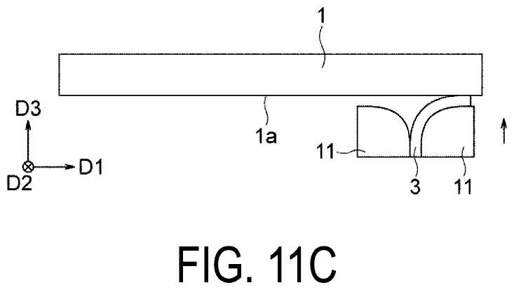

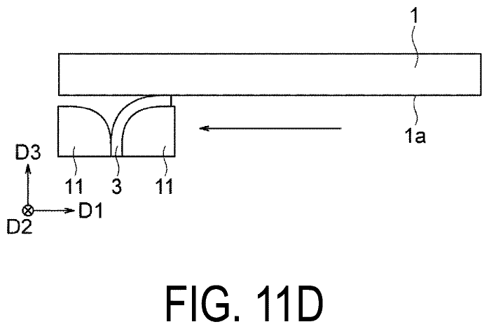

FIGS. 11A to 11D are schematic side views or cross-sectional views illustrating an example of an operation procedure of wiping.

Wiping proceeds in the order of FIGS. 11A, 11B, 11C, and 11D. In this example, it is assumed that wiping is performed with the wiping member 3 sandwiched between the discharge surface 1a and the front end surface 11c of the support member 11 (FIG. 6A). To be specific, the operation procedure of wiping is as follows.

FIG. 11A illustrates a state before wiping is performed. The wiping member 3 is located on the +D1 side of the discharge surface 1a. The front end 3a of the wiping member 3 is located on the +D3 side of the discharge surface 1a.

In FIG. 11B, the support members 11 are moved to the −D1 side. Thus, part of the wiping member 3 on the side of the front end 3a comes into contact with the discharge surface 1a. Also, the body portion 3c of the wiping member 3 is deflected to the +D1 side (in other words, on the opposite side to a traveling direction).

In FIG. 11C, the support members 11 are moved to the +D3 side. Thus, the state described with reference to FIG. 6A and others is obtained. That is, the body portion 3c of the wiping member 3 is sandwiched between the discharge surface 1a and the front end surface 11c of the support member 11.

In FIG. 11D, the support members 11 are moved from the position in 11C to the −D1 side. Thus, wiping is performed. During this period, the distance between the discharge surface 1a and the support member 11 (the force with which the wiping member 3 is pressed against the discharge surface 1a) is, for example, constant.

Note that as indicated by dotted lines in FIG. 11A, on the +D1 side of the discharge surface 1a, an auxiliary member 21 including an inclined surface 21a connected to the discharge surface 1a may be provided. In this case, before the support members 11 start moving toward the −D1 side, the wiping member 3 may be in contact with the inclined surface 21a or may be separated from the inclined surface 21a. Note that the auxiliary member 21 may be a portion of the head 1 or may be a member separate from the head 1.

Unlike FIG. 11A, before wiping, the wiping member 3 may be located on the −D3 side of the discharge surface 1a. Then, the support members 11 may be moved to the −D1 side while being moved to the +D3 side. Alternatively, the support members 11 may be moved to the +D3 side to bring the wiping member 3 into contact with the discharge surface 1a, and then the support members 11 may be moved to the −D1 side. Such operation can also achieve the state illustrated in FIG. 11B.

When changing from the state illustrated in FIG. 11B to the state illustrated in FIG. 11C, the operation described with reference to FIGS. 9A and 9B may be performed. For example, the convex curved surface 11b on the +D1 side may gradually press the liquid retention body 9a on the +D1 side from the −D3 side. When changing from the state illustrated in FIG. 11B to the state illustrated in FIG. 11C, the wiping member 3 may be moved to the −D1 side simultaneously with the movement of the wiping member 3 to the +D3 side. In this case, for example, the operation of the convex curved surface 11b gradually pressing the liquid retention body 9a from the −D3 side is achieved easily.

A movement speed of the wiping member 3 in the D1 direction when wiping is performed by moving from the state illustrated in FIG. 11C to the state illustrated in FIG. 11D may be set as appropriate. For example, this speed may be constant or may change.

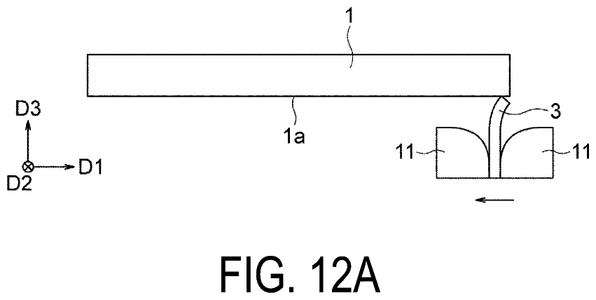

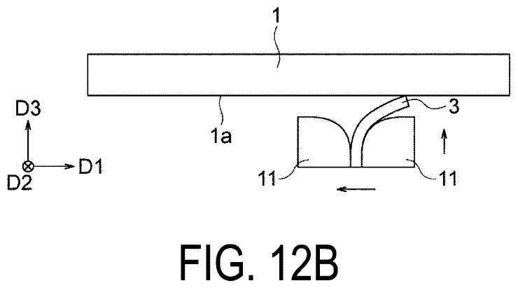

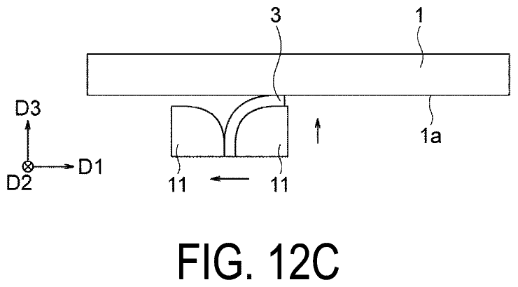

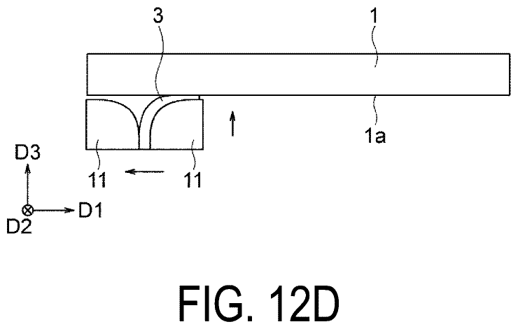

FIGS. 12A to 12D are schematic side views or cross-sectional views illustrating another example of an operation procedure of wiping.

Wiping proceeds in the order of FIGS. 12A, 12B, 12C, and 12D. In this example, while wiping is performed, force with which the wiping member 3 is pressed against the discharge surface 1a changes. To be specific, the operation procedure of wiping is as follows.

In FIG. 12A, a state is the same as, and/or similar to the state illustrated in FIG. 11B. Process up to this state may also be the same as, and/or similar to the example illustrated in FIG. 11B.

In FIG. 12B, the support members 11 are moved from a position in FIG. 12A to the −D1 side. During this period, the support members 11 are also moved to the +D3 side. Thus, operation of moving from the state in FIG. 9A to the state in FIG. 9B is achieved.

In FIG. 12C, the support members 11 are moved further to the −D1 side from a position in FIG. 12B. During this period, the support members 11 are also moved further to the +D3 side. Thus, operation of moving from the state in FIG. 9B to the state in FIG. 6A is achieved.

In FIG. 12D, the support members 11 are moved from a position in FIG. 12C further to the −D1 side. During this period, the support members 11 are also moved further to the +D3 side. Thus, operation of moving from the state in FIG. 10A to the state in FIG. 10B is achieved.

Unlike the illustrated example, when the support members 11 reach a position in FIG. 12D in the D1 direction, the support members 11 may reach the position in FIG. 12C in the D3 direction. Alternatively, the support members 11 may be moved as illustrated in FIGS. 11A to 11C, and then may be moved to the +D3 side while being moved to the −D1 side to reach the position in FIG. 12D from the position in FIG. 11C.

The wiping may be started at appropriate timings. For example, the wiping may be started when a predetermined operation is performed on an operation unit (not illustrated) of the printer. Alternatively, the wiping may be started when a controller of the printer determines that a timing to start wiping has come. These timings may be, for example, when power of the printer is turned on, when printing starts after the power is turned on, and/or when printing continues for a predetermined length of time. The controller may determine whether to perform wiping based on information about the state (e.g., dirt) of the discharge surface 1a. The information about the discharge surface 1a may be obtained, for example, by an imager that captures an image of the discharge surface 1a or a scanner that scans a printed image (a reduction in image quality can indicate need for wiping).

(Other Variations of Wiping Operation)

In the above description, it is assumed that the holding surfaces 11a of the support member 11 are parallel to the D3 direction (orthogonal to the discharge surface 1a) when viewed in the D2 direction. Although not illustrated, the holding surfaces 11a may be inclined with respect to the D3 direction. For example, when the support members 11 are moved to the −D1 side to perform wiping, the holding surfaces 11a may be inclined so as to be positioned on the +D1 side as the holding surfaces 11a is positioned on the +D3 side.

In the above description, when viewed in the D3 direction, it is assumed that the holding surfaces 11a of the support members 11 are parallel to the D2 direction (longitudinal direction of the discharge surface 1a). Although not illustrated, the holding surfaces 11a may be inclined with respect to the D2 direction.

Supply of Cleaning Liquid

As described above, the cleaning liquid may be supplied in wiping. A specific method may be any of various methods, and may be, for example, a method the same as, and/or similar to a known method. Some examples are given below.

Supply Method for Supplying Cleaning Liquid

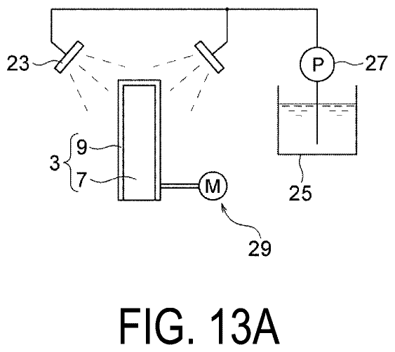

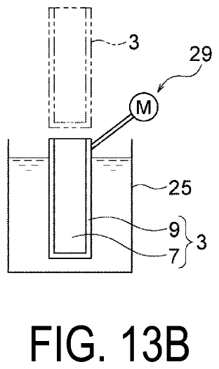

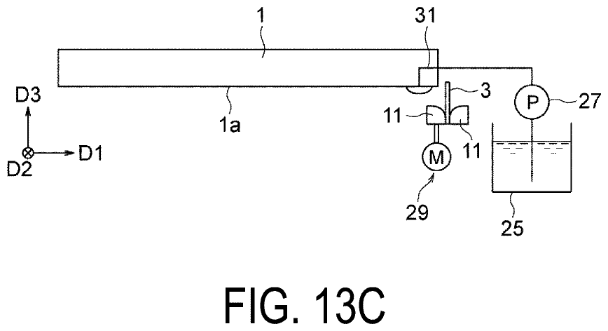

FIG. 13A is a schematic view illustrating an example of a supply method for supplying a cleaning liquid.

In this example, the cleaning liquid is supplied to the wiping member 3 by a shower 23. To be specific, for example, a wiping device including the wiping member 3 and the like includes, in addition to the shower 23, a tank 25 that stores the cleaning liquid and a pump 27 that supplies the cleaning liquid in the tank 25 to the shower 23. A specific configuration of these components may be any appropriate configuration.

Relative movement of the shower 23 and the wiping member 3 to a position at which the cleaning liquid can be supplied to the wiping member 3 by the shower 23 is achieved by moving the shower 23 and/or the wiping member 3 (support members 11). The movement of the wiping member 3 for supplying the cleaning liquid may be performed by a wiper drive mechanism 29 that moves the support members 11 (not illustrated here) relative to the discharge surface 1a for wiping, may be performed by a drive mechanism that moves the entire wiping device, which will be described later, or may be performed by both of them.

FIG. 13B is a schematic view illustrating another example of a supply method for supplying a cleaning liquid.

In this example, the wiping member 3 is dipped into the cleaning liquid stored in the tank 25 to supply the cleaning liquid to the wiping member 3. A specific configuration of the tank 25 may be any appropriate configuration. Relative movement of the wiping member 3 and the tank 25 for dipping the wiping member 3 into the cleaning liquid is achieved by moving the wiping member 3 (support members 11) and/or the tank 25. The movement of the wiping member 3 for supplying the cleaning liquid may be performed by a wiper drive mechanism 29 that moves the support members 11 (not illustrated here) relative to the discharge surface 1a for wiping, may be performed by a drive mechanism that moves the entire wiping device, which will be described later, or may be performed by both of them.

FIG. 13C is a schematic view illustrating still another example of a supply method for supplying a cleaning liquid.

In this example, the cleaning liquid is supplied to the discharge surface 1a. The supply method for supplying the cleaning liquid to the discharge surface 1a may be any of various methods. In the illustrated example, the cleaning liquid is supplied via a channel 31 provided in the head 1 or a member that can be regarded as a portion of the head 1 (e.g., the auxiliary member 21 in FIG. 11A). The channel 31 opens on the discharge surface 1a or a surface connected to the discharge surface 1a (e.g., the inclined surface 21a of the auxiliary member 21). The wiping member 3 retains the cleaning liquid supplied to the discharge surface 1a when the support members 11 are driven by the wiper drive mechanism 29 to start wiping.

Cleaning Liquid

Any of various types of cleaning liquids (components) may be used, and for example, the same as, and/or similar to a known cleaning liquid can be used. An example of the cleaning liquid is, for example, the same as or similar to a solvent in the liquid discharged by the head 1. That is, the cleaning liquid may be the same as or similar to the liquid discharged by the head 1, except that the cleaning liquid does not contain a colorant. For example, the cleaning liquid may be water or an organic solvent. The cleaning liquid may contain a surfactant, an antiseptic, an antifungal agent, or the like as a component that the liquid discharged by the head 1 may or may not contain.

Note that wiping may be performed without supplying the cleaning liquid. For example, wiping may be performed after printing without any cleaning liquid. In this case, for example, the wiping member 3 wipes off ink adhering to the discharge surface 1a during printing. Wiping may be performed without the cleaning liquid after cleaning by so-called capping.

The cleaning by capping is performed, for example, as follows. First, a cap is placed over the discharge surface 1a (not illustrated) (this is referred to as capping) to create a substantially sealed space between the discharge surface 1a and the cap. In such a state, the head 1 repeatedly discharges the liquid to remove, for example, the liquid and/or foreign matters clogged in the nozzles 5 and having viscosity higher than that in the standard state. The cap may then be removed and wiping may be performed.

The wiping member 3 may be cleaned as appropriate. The supply of the cleaning liquid described above may also serve to clean the wiping member 3. Two or more of the supply methods for supplying the cleaning liquid illustrated in FIGS. 13A to 13C may be combined. One of the combined two or more supply methods may mainly contribute to cleaning of the wiping member 3, and another may mainly contribute to the supply of the cleaning liquid. The types (components) of the cleaning liquids used in the two or more supply methods combined may be the same or different.

Printer

Outline of Printer

As mentioned in the description of the head 1, the wiping member 3 may be used in various types of printers. Some examples of printer configurations will be described below. Here, relative movement between the head 1 and the wiping member 3 is particularly focused, and description of a configuration and operation of the printer related to normal printing is basically omitted.

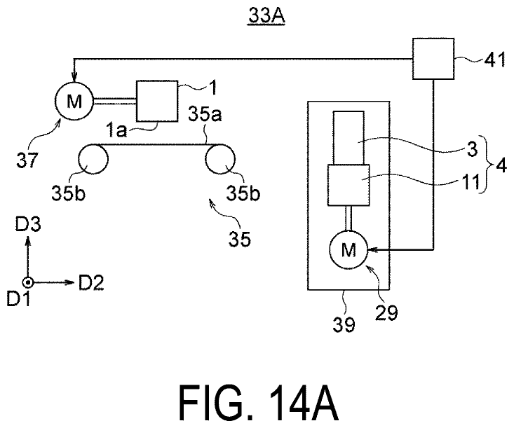

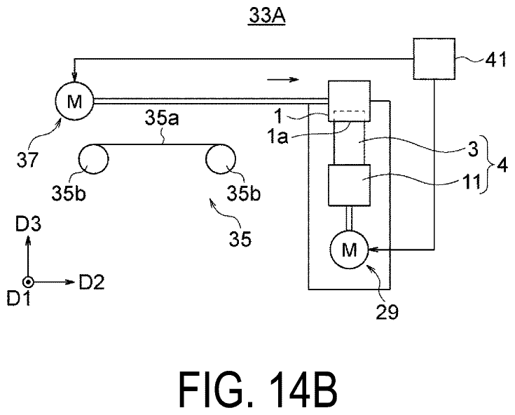

FIGS. 14A and 14B are schematic views illustrating a printer 33A including the wiping member 3. FIG. 14A illustrates a state in which printing is performed. FIG. 14B illustrates a state in which wiping is performed.

The printer 33A includes the head 1 and a conveyance unit 35 that conveys a recording medium (e.g., paper) (not illustrated). Here, the printer 33A is assumed to be a line printer that prints on a recording medium conveyed in the D2 direction (a direction orthogonal to a longitudinal direction of the head 1). The conveyance unit 35 including a belt 35a on which the recording medium is placed and rollers 35b that move the belt is schematically illustrated.

The printer 33A also includes a wiping device 39. The wiping device 39 includes, for example, the wiper 4 (the wiping member 3 and the support members 11) and the wiper drive mechanism 29 that drives the support members 11. The wiper drive mechanism 29 may include, for example, a rotary electric motor or a linear motor. The wiping device 39 may also include a container that stores the cleaning liquid that is splashed and/or dropped.

As illustrated in FIG. 14A, during printing, the head 1 faces the conveyance unit 35 (in more detail, the belt 35a). Thus, printing can be performed by discharging ink droplets from the head 1. As illustrated in FIG. 14B, during wiping, the head 1 is conveyed to a position where the wiping device 39 is located by a head drive mechanism 37. Thus, wiping can be performed. The wiping device 39 may be positioned in any direction with respect to the conveyance unit 35.

The head drive mechanism 37 may include, for example, a rotary electric motor or a linear motor. In the illustrated example, relative movement between the head 1 and the recording medium is achieved by conveying the recording medium by the conveyance unit 35. However, all or some of the relative movement between the head 1 and the recording medium may be achieved by moving the head 1. In this case, a drive mechanism used for moving the recording medium relative to the head 1 may also serve as the head drive mechanism 37 that moves the head 1 to the position of the wiping device 39.

A controller 41 may control the head drive mechanism 37, the wiper drive mechanism 29, and the like. The controller 41 may be, for example, a computer. Although not illustrated, the computer includes, for example, a central processing unit (CPU), a read only memory (ROM), a random access memory (RAM), and an external storage device. The CPU constructs various functional units that perform control and the like by executing programs stored in the ROM and/or the external storage device.

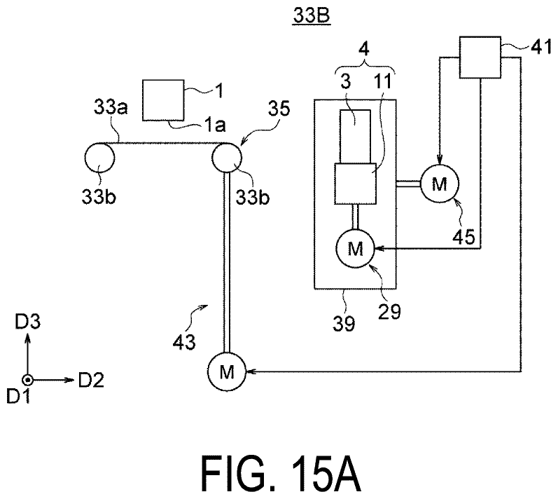

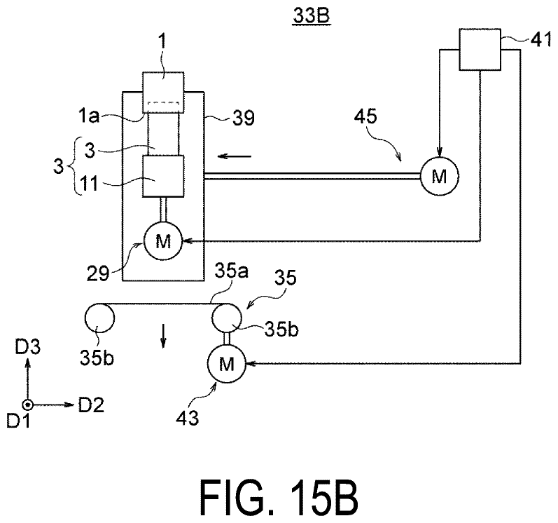

FIGS. 15A and 15B are schematic views illustrating a printer 33B including the wiping member 3 as another example. FIG. 15A illustrates a state in which printing is performed. FIG. 15B illustrates a state in which wiping is performed.

In the printer 33A, switching between the printing state and the wiping state is performed by moving the head 1. On the other hand, in the printer 33B, the above switching is performed by moving the conveyance unit 35 and the wiping device 39. To be specific, the conveyance unit 35 is moved by a conveyance unit drive mechanism 43 from a position facing the head 1 (FIG. 15A) to a position away from the head 1 (FIG. 15B). The wiping device 39 is moved by a wiping device drive mechanism 45 from a position away from the head 1 (FIG. 15A) to a position facing the head 1 (FIG. 15B). Note that when separated from the head 1, the conveyance unit 35 may be positioned in any direction with respect to the head 1.

The conveyance unit drive mechanism 43 may include, for example, a rotary electric motor or a linear motor. The same as, and/or similar to the above, the wiping device drive mechanism 45 may include, for example, a rotary electric motor or a linear motor. The controller 41 controls operation of these mechanisms.

In the above description, the relative movement between the head 1 and the wiper 4 during wiping is achieved by driving the wiper 4 by the wiper drive mechanism 29. However, although not illustrated, at least some of the relative movement between the head 1 and the wiper 4 may be achieved by moving the head 1. As a mechanism for driving the head 1 in this case, a mechanism for moving the head 1 and the recording medium relative to each other for printing may be used, or the head drive mechanism 37 illustrated in FIG. 14B may be used.

### Specific Example of Printer

In the following, an example of the configuration of the printer will be described more specifically than the above. Here, first, a configuration excluding a configuration related to wiping will be described. Then, a configuration of the wiper will be exemplified.

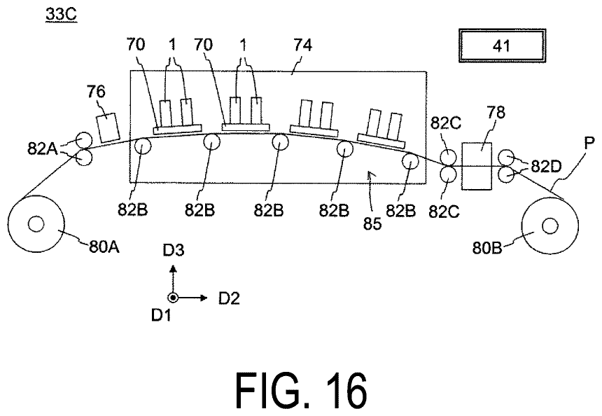

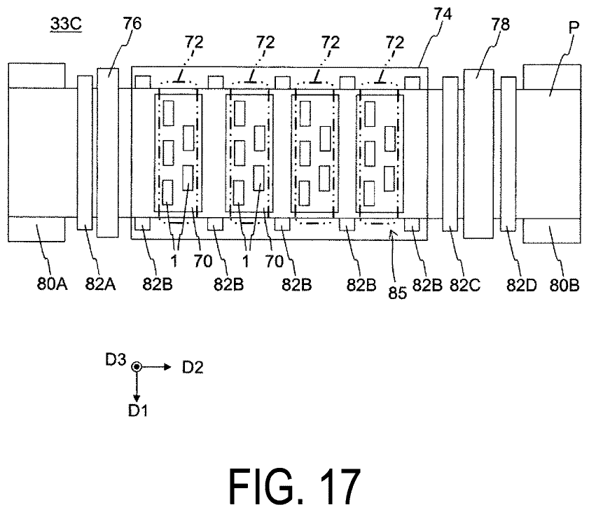

FIG. 16 is a schematic side view of a printer 33C. FIG. 17 is a schematic plan view of the printer 33C.

In these figures, the orthogonal coordinate system D1-D2-D3 defined for the head 1 is shown. As will be understood from a description below, the printer 33C includes multiple heads 1. The multiple heads 1 are oriented slightly differently from each other. Therefore, the orthogonal coordinate system D1-D2-D3 is shown without regard to strictness.

The printer 33C is a line printer that prints on a print sheet P by discharging ink droplets by the heads 1, which are restricted to move, while conveying the print sheet P in the D2 direction (lateral direction of the head 1). To be more specific, the printer 33C moves the print sheet P relative to the heads 1 by conveying the print sheet P from a sheet feed roller 80A to a collection roller 80B. Note that the sheet feed roller 80A, the collection roller 80B, and several rollers to be described later constitute a conveyance unit 85 that moves the print sheet P and the head 1 relative to each other. The controller 41 controls the heads 1 based on print data or the like, which is data such as images and/or characters, to discharge liquid toward the print sheet P and cause droplets to adhere on the print sheet P to perform recording such as printing on the print sheet P.

The printer 33C includes four flat plate-shaped head mounting frames 70 (hereinafter may be simply referred to as frames) so as to be substantially parallel to the print sheet P. Each frame 70 is provided with five holes (not illustrated), and five heads 1 are mounted in the respective holes. The five heads 1 mounted on one frame 70 constitute one head group 72. The printer 33C includes four head groups 72, with a total of 20 heads 1 mounted.

The discharge surfaces 1a (surfaces on the −D3 side) of the heads 1 mounted on the frames 70 face the print sheet P. A distance between the head 1 and the print sheet P is, for example, approximately 0.5 to 20 mm.

The 20 heads 1 may be directly connected to the controller 41 or may be connected to the controller 41 via a distributer that distributes print data. For example, the controller 41 may transmit the print data to one distributer, and the one distributer may distribute the print data to 20 heads 1. Alternatively, for example, the controller 41 may distribute the print data to four distributers corresponding to the four head groups 72, and each distributer may distribute the print data to the five heads 1 in the corresponding head group 72.

In one head group 72, three heads 1 are arranged along a direction intersecting (e.g., a direction substantially orthogonal to) a conveyance direction of the print sheet P, and the other two heads 1 are arranged one by one between the three heads 1 at positions shifted along the conveyance direction. In other words, in one head group 72, the heads 1 are arranged in a zigzag pattern. The heads 1 are arranged so that printable ranges by the respective heads 1 are connected in the width direction of the print sheet P, that is, in the direction intersecting the conveyance direction of the print sheet P, or so that ends of the printable ranges overlap, thereby enabling printing without gaps in the width direction of the print sheet P.

The four head groups 72 are arranged along the conveyance direction of the print sheet P. Liquid (e.g., ink) is supplied to the heads 1 from a liquid supply tank (not illustrated). The heads 1 belonging to one head group 72 are supplied with ink of the same color, and the four head groups 72 can print four colors of ink. The colors of the ink discharged from the respective head groups 72 are, for example, magenta (M), yellow (Y), cyan (C), and black (K). By adhering such inks on the print sheet P, a color image can be printed.

The number of the heads 1 mounted in the printer 33C may be one as long as a printable range with one head 1 is printed in a single color. The number of the heads 1 included in the head group 72 and/or the number of the head groups 72 can be appropriately changed depending on an object to be printed and/or printing conditions. For example, the number of head groups 72 may be increased to print in more colors. When multiple head groups 72 for printing in the same color are arranged to print alternately in the conveyance direction, the conveyance speed can be increased even when the heads 1 having the same performance are used. Thus, the print surface area per hour can be increased. Alternatively, multiple head groups 72 that print in the same color may be prepared and arranged to be shifted in a direction intersecting the conveyance direction, thereby increasing resolution in the width direction of the print sheet P.

In addition to printing with colored inks, in order to treat the surface of the print sheet P, a liquid such as a coating agent may be printed uniformly or patterned by the heads 1. For example, when using a recording medium that is difficult for liquid to permeate, a coating agent that forms a liquid receptive layer can be used so that the liquid is fixed easily. When using a recording medium that is easily permeated with liquid, a coating agent that forms a liquid permeation suppression layer can be used so that the liquid does not spread too much and does not get mixed too much with other liquid adhering next to the liquid. In addition to printing with the heads 1, the coating agent may be uniformly applied with a coater 76 controlled by the controller 41.

The printer 33C prints on the print sheet P, which is a recording medium. The print sheet P is being wound around the sheet feed roller 80A. The print sheet P fed from the sheet feed roller 80A passes under the heads 1 mounted on the frames 70, then passes between two conveyance rollers 82C, and is finally collected by the collection roller 80B. During printing, the print sheet P is conveyed at a constant speed by rotating the conveyance rollers 82C, and printing is performed by the heads 1.

Details of the printer 33C will be described in the order in which the print sheet P is conveyed. The print sheet P fed from the sheet feed roller 80A passes between two guide rollers 82A, and then passes under the coater 76. The coater 76 coats the print sheet P with the coating agent described above.

Subsequently, the print sheet P enters a head chamber 74 housing the frames 70 on which the heads 1 are mounted. Some portions of the head chamber 74 communicate with the outside such as portions where the print sheet P enters and exits, but the head chamber 74 is a space substantially separated from the outside. As necessary, control factors such as temperature, humidity, air pressure, and the like in the head chamber 74 are controlled by the controller 41 and the like. The head chamber 74 can be less affected by disturbance than the outside where the printer 33C is installed, so variation ranges of the control factors described above can be made narrower than the outside.

Five guide rollers 82B are arranged in the head chamber 74, and the print sheet P is conveyed on the guide rollers 82B. The five guide rollers 82B are arranged so as to be convex at the center in the direction in which the frames 70 are arranged when viewed from the side. Thus, the print sheet P conveyed on the five guide rollers 82B has an arc shape when viewed from the side, and by applying tension to the print sheet P, the print sheet P between the guide rollers 82B is stretched to be a flat shape. One frame 70 is placed between the two guide rollers 82B. The frames 70 are installed at slightly different angles so as to be parallel to the print sheet P conveyed under the frames 70.

The print sheet P fed out from the head chamber 74 passes between the two conveyance rollers 82C, passes through a dryer 78, passes between the two guide rollers 82D, and is collected by the collection roller 80B. A conveyance speed of the print sheet P is, for example, 100 m/min. The rollers each may be controlled by the controller 41 or may be manually operated by a person.

Drying with the dryer 78 suppresses adhesion at overlapped portions of the print sheet P wound around the collection roller 80B and rubbing of undried liquid. Rapid drying is required for high speed printing. For rapid drying, in the dryer 78, multiple drying methods may be used in sequence or multiple drying methods may be used simultaneously. Drying methods used in such cases include, for example, hot air blowing, infrared irradiation, and contact with a heated roller. When irradiating with infrared rays, infrared rays in a specific frequency range may be applied to allow rapid drying while reducing damage to the print sheet P. When the print sheet P is brought into contact with the heated roller, the print sheet P may be conveyed along a cylindrical surface of the roller to extend heat transfer time. A range of the cylindrical surface along which the print sheet P is conveyed is preferably ¼ or more of the cylindrical surface of the roller, and more preferably ½ or more of the cylindrical surface of the roller. When printing UV curable ink or the like, UV irradiation light sources may be placed instead of or in addition to the dryer 78. The UV irradiation light sources may be placed between the frames 70.

As the recording medium, in addition to the print sheet P, a roll of cloth or the like may be used. Instead of directly conveying the print sheet P, the printer 33C may convey the recording medium placed on the conveyor belt by conveying a conveyor belt. In this way, a sheet of paper, cut cloth, wood, or a tile can be the recording medium. By discharging liquid containing electrically conductive particles from the heads 1, for example, a wiring pattern of an electronic device may be printed. Chemicals may be produced by discharging a predetermined amount of chemical agent or a liquid containing a chemical agent from the heads 1 toward reaction vessels or the like and causing them to react.

A position sensor, a speed sensor, and/or a temperature sensor may be attached to the printer 33C, and the controller 41 may control the units of the printer 33C in accordance with the states of the units of the printer 33C as determined by information from the sensors. For example, when a temperature of the head 1, a temperature of the liquid in the liquid supply tank that supplies the liquid to the head 1, and/or a pressure applied to the head 1 by the liquid in the liquid supply tank affects discharge characteristics (e.g., discharge amount and/or discharge speed) of the liquid to be discharged, a drive signal for discharging the liquid may be changed according to such information.

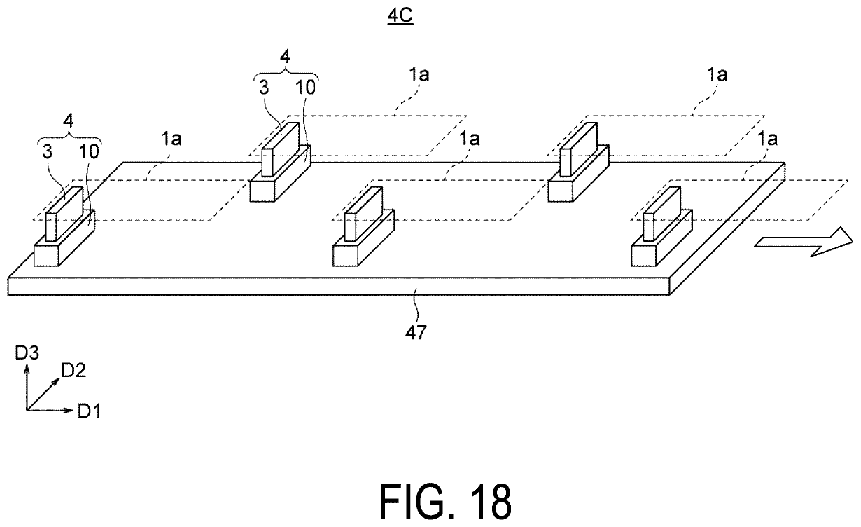

FIG. 18 is a schematic view illustrating a configuration of a wiper 4C used in the printer 33C. Here, the discharge surfaces 1a of the heads 1 are also indicated by dotted lines.

The wiper 4C includes multiple (five in the illustrated example) wipers 4 and a connection member 47 that connects the multiple wipers 4. The wiper 4 has the configuration described with reference to FIG. 5 and others, and includes the wiping member 3 and the holding unit 10 (illustrated more schematically than in FIG. 5 and others). The number and relative positions of the multiple wipers 4 correspond to the number and relative positions of the heads 1 included in one head group 72. Thus, by moving the wiper 4C in the D1 direction, all the heads 1 included in one head group 72 can be wiped. A shape of the connection member 47 is freely set, and may be, for example, plate-like (illustrated example) or skeleton-like.

Although not illustrated, unlike the illustrated example, for example, further multiple wipers 4C corresponding to the multiple head groups 72 may be connected to form a wiper. Alternatively, the wipers 4 corresponding to the multiple heads 1 of one head group 72 may be driven independently without being connected to each other. One wiper 4 (FIG. 5 and others) may be relatively large so as to be able to wipe the multiple heads 1 of one head group 72. When the discharge surfaces 1a of the respective multiple head groups 72 are positioned on the same plane, one wiper 4 may be relatively large so as to be able to wipe the discharge surfaces 1a of the respective multiple head groups 72. One wiper 4 may be moved relative to the multiple heads 1 so as to sequentially wipe the multiple heads 1.

As described above, in the present embodiment, the wiping member 3 includes the elastic member 7 and the liquid retention member 9. The elastic member 7 includes a first surface and a second surface (e.g., two main surfaces 7a) facing in different directions. The liquid retention member 9 overlaps the elastic member 7 over the first surface and the second surface, and has liquid retention properties.

Thus, for example, the elastic member 7 having elasticity can be used to press the liquid retention member 9 containing the cleaning liquid against the discharge surface 1a for wiping. This improves a cleaning effect by wiping. The liquid retention member 9 extends over two surfaces (e.g., two main surfaces 7a) of the elastic member 7. Thus, for example, as can be understood from the description given above relating to FIGS. 9A and 9B, in addition to a portion (e.g., one of the two liquid retention bodies 9a) that directly contributes to wiping by being in contact with the discharge surface 1a, the liquid retention member 9 can include a portion (e.g., the other of the two liquid retention bodies 9a) that supplies the cleaning liquid to the head 1. As a result, for example, an amount of the cleaning liquid retained by the wiping member 3 can be increased, and the cleaning liquid free from contaminants on the discharge surface 1a can be supplied to the discharge surface 1a. For example, with one supply of the cleaning liquid and/or one cleaning of the wiping member 3, wiping can be performed twice, once with a portion located on one of the two surfaces (e.g., one of the two liquid retention bodies 9a) in contact with the discharge surface 1a, and once with a portion located on the other of the two surfaces (e.g., the other of the two liquid retention bodies 9a) in contact with the discharge surface 1a. As a result, efficiency of operation related to wiping is improved.

The first surface and the second surface (e.g., the two main surfaces 7a) may face opposite sides.

In this case, for example, in an aspect in which the wiping is performed twice with one supply of the cleaning liquid and/or one cleaning of the wiping member 3 as described above, the configuration of the transport device (e.g., the wiper drive mechanism 29) that moves the head 1 and the wiping member 3 relative to each other is simplified. To be specific, for example, when wiping is performed with the holding surfaces 11a of the support members 11 orthogonal to the D1 direction as in the embodiment, the movement direction of the support members 11 need only be switched between the +D1 side and the −D1 side.

In the wiping member 3, the liquid retention member 9 may be wrapped around the elastic member 7.

In this case, for example, the wiping member 3 including the liquid retention member 9 can be configured simply by wrapping a flexible sheet such as cloth around the elastic member 7, thereby facilitating production of the wiping member 3. For example, the wiping member 3 can be configured such that the liquid retention member 9 is detachable from the elastic member 7. As can be understood from a comparison between FIGS. 2B and 3A, a thickness of the liquid retention member 9 can be adjusted simply by changing the number of wrappings. That is, it is easy to adjust the thickness of the liquid retention member 9, which affects a cleaning effect by wiping. In general, a water retention rate of multiple pieces of cloth stacked on each other is higher than a water retention rate of a single piece of cloth. This is because water is retained between the cloths. Thus, by increasing the number of wrappings, an amount of cleaning liquid retained can be increased efficiently.

According to the embodiment, the wiper 4 may include the wiping member 3 and the support members 11 that support the wiping member 3. The wiping member 3 may include the front end 3a and the rear end 3b, which are end portions on both sides in the direction along a first surface and a second surface (e.g., two main surfaces 7a) facing opposite sides. The wiping member 3 may include the body portion 3c including the front end 3a and the held portion 3d located closer to the rear end 3b than the body portion 3c. The support member 11 may have the holding surface 11a and the convex curved surface 11b. The holding surface 11a may be in contact with the held portion 3d from the side that the second surface (+D1 side) faces to enable deflection of the body portion 3c toward the side that the second surface (e.g., the main surface 7a on the +D1 side) faces. The convex curved surface 11b is connected to the holding surface 11a on the side of the front end 3a, and may curve away from the wiping member 3 being in a non-deflecting state toward the side that the second surface (+D1 side) faces the closer the convex curved surface 11b is located to the front end 3a.

In this case, for example, stress concentration in the wiping member 3 is reduced. To be specific, for example, an aspect in which the holding surface 11a and the front end surface 11c are orthogonal to each other without providing the convex curved surface 11b in the support member 11 or an aspect in which only the support members 11A in FIG. 7A are used (these aspects are also included in a technology according to the present disclosure) will be considered. In these aspects, when the wiping member 3 is deflected toward a corner portion, stress concentration occurs at a portion of the wiping member 3 that is in contact with the corner portion. On the other hand, in the aspect in which the convex curved surface 11b is provided, the wiping member 3 comes into contact with the convex curved surface 11b and deforms along the convex curved surface 11b, which reduces the stress concentration. The convex curved surface 11b facilitates, as described with reference to FIGS. 9A and 9B, the operation in which the liquid retention body 9a is pressed sequentially from the portion away from the discharge surface 1a. As a result, for example, the cleaning liquid can be squeezed out over a long travel distance in the D1 direction.

According to the embodiment, the wiper 4 may include the wiping member 3 and a first support member and a second support member (two support members 11). The wiping member 3 may include a first surface and a second surface (e.g., two main surfaces 7a) facing opposite sides. The first support member (e.g., the support member 11 on the −D1 side) may be in contact with the wiping member 3 from the side (−D1 side) that the first surface (e.g., the main surface 7a on the −D1 side) faces. The second support member (e.g., the support member 11 on the +D1 side) may be in contact with the wiping member 3 from the side (+D1 side) that the second surface (e.g., the main surface 7a on the +D1 side) faces.

In this case, for example, when the holding unit 10 including the two support members 11 is moved to either the −D1 side or the +D1 side, the wiping member 3 can be supported by the support members 11. That is, wiping in two directions using the two liquid retention bodies 9a located on the two main surfaces 7a facing the opposite sides is facilitated.

According to the embodiment, the wiping method includes the wiping step of wiping the discharge surface 1a of the head 1 on which the nozzle 5 opens with the wiping member 3 (e.g., FIGS. 11A to 11D). The wiping member 3 may include the front end 3a and the rear end 3b, which are end portions on both sides in the direction along a first surface and a second surface (e.g., two main surfaces 7a) facing opposite sides. The wiping member 3 may include the body portion 3c including the front end 3a and the held portion 3d located closer to the rear end 3b than the body portion 3c. The liquid retention member 9 may include a first portion (e.g., the liquid retention body 9a on the −D1 side) and a second portion (e.g., the liquid retention body 9a on the +D1 side). The liquid retention body 9a on the −D1 side may be located on the body portion 3c and on a first surface (e.g., the main surface 7a on the −D1 side). The liquid retention body 9a on the +D1 side may be located on the body portion 3c and on a second surface (e.g., the main surface 7a on the +D1 side). The wiping step may include a contact step of bringing the body portion 3c into contact with the discharge surface 1a while holding the held portion 3d to enable deflection of the body portion 3c (e.g., FIGS. 11A and 11B). The wiping step may include a first step of moving the wiping member 3 in a first direction (e.g., the −D1 side, but not necessarily orthogonal to a first surface) that the first surface faces in the held portion 3d, the first direction being a direction along the discharge surface 1a, with the body portion 3c in contact with the discharge surface 1a (e.g., FIGS. 11C and 11D). In the first step, the wiping member 3 may be moved to the −D1 side while pressing the liquid retention body 9a on the +D1 side toward the main surface 7a on the +D1 side with the liquid retention body 9a on the −D1 side in contact with the discharge surface 1a.

In this case, for example, as can be understood from the above description, not only the cleaning liquid retained by the liquid retention body 9a in contact with the discharge surface 1a, but also the cleaning liquid retained by the liquid retention body 9a on the opposite side can be squeezed out to use. Note that in the above description, the support member 11 presses the liquid retention body 9a, which is not in contact with the discharge surface 1a, as the support member 11 is moved to the +D3 side. However, the pressing may be achieved by pressing a member other than the support member 11 against the liquid retention body 9a using an appropriate drive mechanism or human power.

In the first step (e.g., FIGS. 12A to 12D), the closer the region to the discharge surface 1a, the later the timing of pressing the second portion (e.g., the liquid retention body 9a on the +D1 side) toward the second surface (e.g., the main surface 7a on the +D1 side) (e.g., FIGS. 12A to 12C, and FIGS. 9A, 9B, and 6A).

In this case, as described with reference to FIGS. 9A and 9B, the operation of pressing the liquid retention body 9a sequentially from the portion away from the discharge surface 1a is facilitated. As a result, for example, the cleaning liquid can be squeezed out over a long travel distance in the D1 direction. Note that in the above description, the operation of pressing sequentially from the position away from the discharge surface 1a is achieved by the convex curved surface 11b. However, such pressing may be achieved by pressing a surface having a shape other than the convex curved surface 11b against the liquid retention body 9a sequentially from a position away from the discharge surface 1a by an appropriate drive mechanism or human power.

According to the embodiment, the wiping step of the wiping method may include a first step (e.g., FIG. 6A) and a second step (e.g., FIG. 6B). In the first step, with a first portion (e.g., the liquid retention body 9a on the −D1 side) in contact with the discharge surface 1a, the wiping member 3 may be moved in a first direction (e.g., the −D1 side, but not necessarily orthogonal to a first surface) that the first surface (e.g., the main surface 7a on the −D1 side) faces in the held portion 3d, the first direction being a direction along the discharge surface 1a. In the second step, with the second portion (e.g., the liquid retention body 9a on the +D1 side) in contact with the discharge surface 1a, the wiping member 3 may be moved in a second direction (e.g., the +D1 side, but not necessarily orthogonal to the first surface) that a second surface (e.g., the main surface 7a on the +D1 side) faces in the held portion 3d, the second direction being the direction along the discharge surface 1a.

In this case, for example, both of the two liquid retention bodies 9a located on the two main surfaces 7a are used as portions that directly contribute to wiping by being in contact with the discharge surface 1a. As a result, for example, wiping can be performed twice with one supply of the cleaning liquid and/or one cleaning of the wiping member 3, thereby improving efficiency of cleaning.

In the first step (e.g., FIGS. 12A to 12D), the force with which the wiping member 3 is pressed toward the discharge surface 1a may be changed. From another viewpoint, the distance between the support member 11 and the discharge surface 1a may be changed.

In this case, for example, by increasing the force for pressing the wiping member 3 toward the discharge surface 1a as wiping (movement in the D1 direction) progresses, the cleaning liquid remaining in at least one of the two liquid retention bodies 9a can be squeezed out. As a result, for example, the cleaning liquid can be supplied to the discharge surface 1a not only at the initial stage of wiping, but also thereafter. Consequently, this facilitates maintaining a cleaning effect until the end of wiping.

The wiping method may further include a preparation step (e.g., refer to FIGS. 2A, 2B, and 3) of setting the thickness of the liquid retention member 9 in accordance with at least one of the type of liquid discharged by the head 1 and the timing at which the wiping step is performed.

In this case, for example, when the discharge surface 1a is easily contaminated, an amount of the cleaning liquid to be retained is increased by setting the liquid retention member 9 to be thick, enhancing a cleaning effect.

According to the embodiment, a liquid discharge device (e.g., the printers 33A, 33B, and 33C) may include the wiping member 3 and a transport device (e.g., the wiper drive mechanism 29). The transport device moves the wiping member 3 and the head 1 relative to each other so that the wiping member 3 wipes the discharge surface 1a of the head 1 on which the nozzle 5 opens.

Since such a liquid discharge device includes the wiping member 3 described above, the discharge surface 1a is cleaned effectively. As a result, for example, the droplet discharge characteristics are stabilized, thereby stabilizing the image quality.

In the above-described embodiment and the like, each of the main surface 7a, the side surface 7b, and the inclined surface 7c on which the liquid retention member 9 overlaps is an example of the first surface or the second surface. The two main surfaces 7a (and the two side surfaces 7b) are examples of the first surface and the second surface facing opposite sides. The two support members 11 (or 11A) are examples of the first support member and the second support member. The two liquid retention bodies 9a are examples of the first portion and the second portion. The wiper drive mechanism 29 is an example of the transport device. Each of the printers 33A, 33B, and 33C is an example of the liquid discharge device.

Note that the technology according to the present disclosure is not limited to the embodiment described above, and may be implemented in various aspects.

One wiping member may have two or more types of liquid retention members. For example, liquid retention members made of different materials may be stacked one on top of the other. Different materials may be located in different regions on the surface of the elastic member. The wiping member may include a member other than the elastic member and the liquid retention member. For example, the wiping member may include, inside the elastic member, a member having a higher Young's modulus than that of the elastic member that restricts deflection of the wiping member.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A wiping member comprising:
an elastic member comprising a first surface and a second surface facing in different directions; and
a liquid retention member overlapping the elastic member over the first surface and the second surface and having liquid retention properties.

2. The wiping member according to claim 1, wherein
the first surface and the second surface face opposite sides.

3. The wiping member according to claim 1, wherein
the liquid retention member is wrapped around the elastic member.

4. A wiper comprising:
the wiping member according to claim 2; and
a support member configured to support the wiping member, wherein
the wiping member comprises
a front end and a rear end, the front end and the rear end being end portions on both sides in a direction along the first surface,
a body portion comprising the front end, and
a held portion located closer to the rear end than the body portion, and
the support member comprises
a holding surface being in contact with the held portion from a side that the second surface faces to enable deflection of the body portion toward the side that the second surface faces, and
a convex curved surface connected to the holding surface on a side of the front end and curving away from the wiping member being in a non-deflecting state toward the side that the second surface faces the closer the convex curved surface is located to the front end.

5. A wiper comprising:
the wiping member according to claim 2;
a first support member in contact with the wiping member from a side that the first surface faces; and
a second support member in contact with the wiping member from a side that the second surface faces.

6. A wiping method comprising:
wiping, with the wiping member according to claim 2, a discharge surface of a liquid discharge head on which a nozzle opens, wherein
the wiping member comprises
a front end and a rear end, the front end and the rear end being end portions on both sides in a direction along the first surface,
a body portion comprising the front end, and
a held portion located closer to the rear end than the body portion,
the liquid retention member comprises
a first portion located on the body portion and on the first surface, and
a second portion located on the body portion and on the second surface,
the wiping comprises
bringing the body portion into contact with the discharge surface while holding the held portion to enable deflection of the body portion, and
moving the wiping member in a first direction in which the first surface faces in the held portion, the first direction being a direction along the discharge surface, with the body portion in contact with the discharge surface, and
in the moving of the wiping member, the wiping member is moved in the first direction while pressing the second portion toward the second surface with the first portion in contact with the discharge surface.

7. The wiping method according to claim 6, wherein
in the moving of the wiping member in the first direction, the second portion is pressed toward the second surface at a later timing in a region closer to the discharge surface.

8. A wiping method comprising:
wiping, with the wiping member according to claim 2, a discharge surface of a liquid discharge head on which a nozzle opens, wherein
the wiping member comprises
a front end and a rear end, the front end and the rear end being end portions on both sides in a direction along the first surface,
a body portion comprising the front end, and
a held portion located closer to the rear end than the body portion,
the liquid retention member comprises
a first portion located on the body portion and on the first surface, and
a second portion located on the body portion and on the second surface, and
the wiping comprises
bringing the body portion into contact with the discharge surface while holding the held portion to enable deflection of the body portion,
moving the wiping member in a first direction in which the first surface faces in the held portion, the first direction being a direction along the discharge surface, with the first portion in contact with the discharge surface, and
moving the wiping member in a second direction in which the second surface faces in the held portion, the second direction being a direction along the discharge surface, with the second portion in contact with the discharge surface.

9. The wiping method according to claim 6, wherein
in the moving of the wiping member in the first direction, a force with which the wiping member is pressed toward the discharge surface is changed.

10. The wiping method according to claim 6, further comprising:
setting a thickness of the liquid retention member according to a type of liquid to be discharged by the liquid discharge head and/or a timing at which the wiping is performed.

11. A liquid discharge device comprising:
the wiping member according to claim 1; and
a transport device causing the wiping member to wipe a discharge surface of a liquid discharge head on which a nozzle opens by moving the wiping member and the liquid discharge head relative to each other.
